(19) United States
(12) Patent Application Publication
(10) Pub. No.: US 2026/0030505 A1
(43) Pub. Date: Jan. 29, 2026

(54) SYSTEMS AND METHODS FOR GENERATING AND USING CATEGORY SPECIFIC OPTIMISED WORKFLOWS FOR LIVE CONVERSATIONS

(71) Applicant: Ema Unlimited Inc., Mountain View, CA (US)

(72) Inventors: Soham Pranav Shah, Redwood City, CA (US); Souvik Sen, Sunnyvale, CA (US); Surojit Chatterjee, Los Altos Hills, CA (US)

(21) Appl. No.: 18/786,551

(22) Filed: Jul. 28, 2024

(51) Int. Cl. G06N 3/0895

(52) U.S. Cl. CPC G06N 3/0895; G06Q 10/0633

(57) ABSTRACT

Systems and methods for using large language models (LLMs) to analyze category specific workflows for generating an optimized workflow that can be used in live conversations to provide a response are described. The methods include categorizing a plurality of projects into specific categories. The actions performed by agents for the plurality of projects are translated into workflows. The workflows are analyzed based on optimization factors and clustering options, such as including redundancies in workflow steps, using alternative solutions to a workflow step, determining whether any escalation performed is justified and if so, adopting escalation related steps. The workflows are consolidated and optimized into an optimized workflow that is tested and verified, and then used in a live conversation.

### CROSS-REFERENCE TO RELATED APPLICATIONS

This application is a continuation-in-part (CIP) of U.S. patent application Ser. No. 18/610,276, filed Mar. 20, 2024, the disclosures of this application are incorporated herein by reference in its entirety.

### FIELD OF DISCLOSURE

Embodiments of the present disclosure relate to using large language models (LLMs) to generate category specific workflows that can be used in live conversations to provide a response. Embodiments of the present disclosure also relate to optimizing a model used by the LLM by eliminating workflow redundancies and incorporating feedback to generate the optimized model.

### BACKGROUND

Large language models (LLMs) are a component of artificial intelligence (AI) generative systems that are utilized by chatbots and other platforms to respond to user inquiries. These LLM models are trained with extensive amount of data which is then used to predict subsequent words and formulate replies to users.

While LLMs can be leveraged to answer certain types of simple and complex queries, they are still considered to be in their nascent stages with significant potential for growth. For example, responses obtained using current LLM models are not utilized to refine the models for improved outcomes. If a response is unsatisfactory, a user must submit a new or altered query to the LLM (e.g., via a chatbot), hoping for a better answer. This repetition or rephrasing of queries and requests can be inefficient and burdensome for users, leading to increased computational resource usage.

Some recent trends include using AI in a customer service environment, which involves leveraging LLMs to provide answers to customer queries. However, such uses in customer service environment has several drawbacks. One such drawback of using an AI system in the customer service environment includes their limitations and inability to process natural language and accurately determine the user's intent in order to provide a desired and/or accurate response to the user. Instead, standard responses or scripts are provided to the user making it an unpleasant customer service experience.

As such, there is a need for more efficient and less cumbersome methods and systems for training, optimizing, and using LLMs in a live setting for responding to user queries and completing projects in an enterprise setting.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a flowchart of an example of a process for generating category specific workflows by leveraging one or more LLMs and using them in a live conversational environment, in accordance with some embodiments of the disclosure;

FIG. 2 is a block diagram of an example of a system for generating category specific workflows by leveraging one or more LLMs and using them in a live conversational environment, in accordance with some embodiments of the disclosure;

FIG. 3 is a block diagram of an example of an electronic device for using LLMs and generated and/or optimized workflows and LLM to respond to queries, in accordance with some embodiments of the disclosure;

FIG. 4 is a block diagram of a first example of a ticket that includes a conversation between a user and an agent, in accordance with some embodiments of the disclosure;

FIG. 5 is a block diagram of a second example of a ticket that includes a conversation between a user and an agent, in accordance with some embodiments of the disclosure;

FIG. 6 is a block diagram of categorization of projects, such as by using an LLM, in accordance with some embodiments of the disclosure;

FIG. 7 is a block diagram of workflows associated with separate projects from a same category, in accordance with some embodiments of the disclosure;

FIG. 8 is a block diagram of clustering options used to cluster steps of workflows used by separate projects that belong to a same category, in accordance with some embodiments of the disclosure;

FIG. 9 is a block diagram of optimization factors used to optimize a workflow that is to be used in a conversational environment for handling live projects, in accordance with some embodiments of the disclosure;

FIG. 10 is a flowchart of an example of a process for generating and executing a search and execute plan for providing a response in a live conversational environment, in accordance with some embodiments of the disclosure;

FIG. 11 is a flowchart of an example of a process for optimizing a workflow, in accordance with some embodiments of the disclosure;

FIG. 12 is a flowchart of an example of a process for evaluating escalations and determining whether to incorporate escalation related workflow steps into the optimized workflow, in accordance with some embodiments of the disclosure;

FIG. 13 is a block diagram of scores calculated based on the similarity between an LLM response and a live agent response for an already executed project, in accordance with some embodiments of the disclosure;

FIG. 14 is a block diagram of comparing agent response score and LLM response score, based on their responses for an already executed project, to a predetermined standard, in accordance with some embodiments of the disclosure;

FIG. 15 is a flowchart of an example of a process for testing the optimized model with the optimized workflow steps against an agent response and refining the model and its workflow steps as needed, in accordance with some embodiments of the disclosure; and

FIG. 16 is a flowchart of a process for using the optimized LLM model in a live environment to provide responses, in accordance with some embodiments of the disclosure.

### DETAILED DESCRIPTION

In accordance with some embodiments disclosed herein, the above-mentioned limitations are overcome by using an LLM (or other alternatives, such as neural networks, state machines, etc.) to analyze queries, conversations, and actions performed, such as by an agent, in a plurality of projects that fall under a same category, generating plurality of workflows for each of the projects analyzed, based on the analysis, generating an optimized model with an optimized workflow from the plurality of workflows, and using, by the LLM, the optimized model with an optimized workflow to provide responses in a live project or live environment.

In some embodiments, an LLM leveraging an optimized model may provide responses to user queries or complete user requests and projects in a live conversational setting. For the LLM to be made ready to provide such responses or complete such projects, it may first be trained. The training of the LLM may include accessing a plurality of projects. The projects, in some embodiments, may be identified by an enterprise. In other embodiments, the LLM may select a sampling of projects from the plurality of projects accessed.

For the training purposes, each project used (either identified by the enterprise or selected based on sampling by the LLM) may include a conversation between an agent and a user. For example, a project may relate to a trouble ticket that was originated to solve a problem, provide customer service, or assist the user with a particular need, such as a help desk need. As part of providing the solution to the trouble ticket, the agent and user may have conversed with each other and during the conversation the agent may have provided responses to the user relating to the trouble ticket in order to resolve the issue(s) related to the trouble ticket. The conversation may include a plurality of back-and-forth steps between the agent and the user in which the user may provide information, agent may ask for clarifications or additional information, and the agent may troubleshoot the problem faced by the user and try various methods to solve the problem.

In some embodiments, all the projects may be categorized under a range of categories, where each category may be representative of the type of project. For example, if the project is a ticket, such as a trouble ticket or a help desk ticket, for a user having logging in issues, then a category may be generated where all projects where logging in was an issue may be identified under the generated category.

In some embodiments, conversations between user and agent, methods used by the agent to solve the user's problems, back-and-forth conversational interactions where information or clarification is sought or provided, and all the steps taken by the agent may be analyzed to determine which steps may be used as a workflow step for a model to be generated. An LLM may be used to perform the analysis and use its results to generate a workflow for the process used by the agent in completing a particular project or providing a solution to a trouble ticket. Such workflows for completed projects may be generated for all projects that are to be used as training for the LLM to generate an optimized model. The workflows and completed projects may be stored in a database.

In some embodiments, the LLM may analyze all the workflows generated for completed projects, where the workflows may represent the process used by the agent in completing the project (e.g., providing a solution to the issue presented in a trouble ticket). The LLM may apply optimization factors, which include removing redundancies, combining workflow steps, determining alterative approaches and steps to achieve a same or similar solution, eliminating steps that are not needed, analyzing escalations and their justification, curating escalation steps, etc.

Once generated workflows are analyzed based on optimization factors, an optimized workflow may be generated. The optimized workflow may then be tested to determine whether an LLM using the optimized workflow performs as anticipated. In some embodiments, the testing may include the LLM providing responses to previously completed projects, or solving issues presented in the completed projects. Since the projects were already completed by a human agent, testing may include comparing the LLM response or solution to either the agent's response/solution or to a predetermined standard. If a determination is made that the LLM using the optimized model provided answers or solutions that are either as good as the answers or solutions provided by the agent, within a threshold of the answers or solutions provided by the agent, such as a threshold percentage or score, or within a threshold of the ideal or standard answers or solutions provided by the enterprise, then the LLM using the optimized model may be determined to be working as anticipated. In other words, the LLM may deemed to be performing with a desired accuracy. As such, the LLM may be deemed to be ready to handle live projects using the optimized model. Prior to handling any live projects, information in the optimized model may be kept updated. The updating may involve accessing a knowledge base that includes a semantic graph of all enterprise knowledge and data and determining if any enterprise information has changed. If a change is determined, then the knowledge based and associated semantic graphs may be updated and the updated information may be used when executing the optimized model.

On the other hand, if a determination is made that the LLM using the optimized model provided answers or solutions that are not as good as the answers or solutions provided by the agent, e.g., not within a threshold of the answers or solutions provided by the agent, or not within a threshold of the ideal or standard answers or solutions provided by the enterprise, then the LLM using the optimized model may be retrained and optimized until the LLM provided answers or solutions are satisfactory, i.e. are within the predetermined threshold. The predetermined threshold may be provided by the enterprise, the user, agent, or automatically generated based on a level of response accuracy desired. Since accuracy may be related to costs, e.g., higher accuracy requiring higher level of computation and costs, a balance between accuracy and cost may be considered in determining the predetermined threshold.

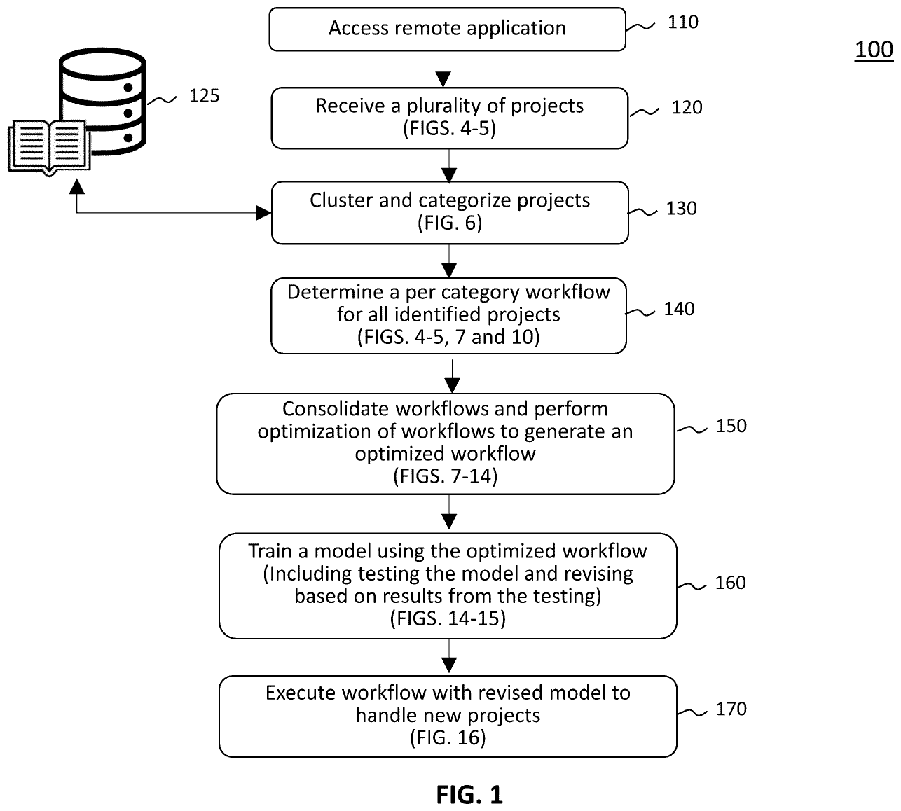

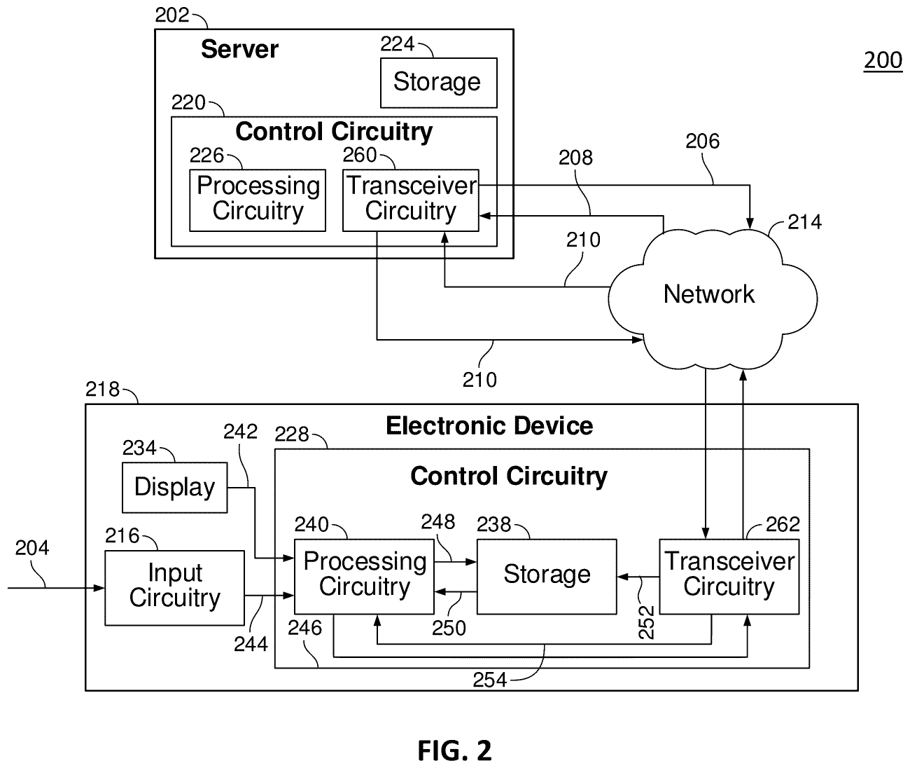

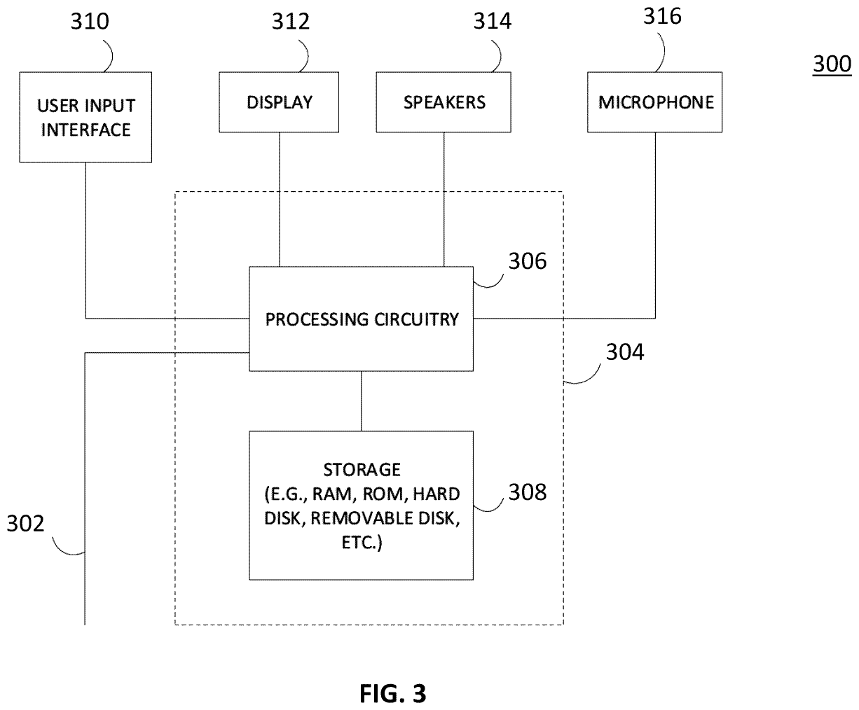

Turning now to figures, FIG. 1 is a flowchart of an example of a process 100 for generating category specific workflows by leveraging one or more LLMs and using them in a live conversational environment, in accordance with some embodiments of the disclosure. Although references are made to an LLM in FIG. 1 (and other embodiments herein), the embodiments are not so limited and include all types of multimodal models and system, including neural network models, state space models, language models of varying sizes, groups or LLMs, etc. The process 100, as depicted in FIG. 1, may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

In some embodiments, the process may be initiated at block 110 by an LLM accessing a remote application, such as a ticketing application. The process may involve an LLM sending a request to the application for access. In some embodiment, the LLM may send user credentials for the user that will be using the LLM to obtain a response to the query. The application may authorize user access based on the credential received and allow the integration of the application. In some embodiments, based on the user query, the LLM may automatically determine which application is to be used, and automatically perform all the steps to access the application and the data stored related to the projects previously completed using such application.

At block 120, the LLM may receive a plurality of projects. As described above, the projects may be performed in a conversational environment where a user provides an input and seeks to receive a response via a conversation with an agent.

For example, such a project may relate to a customer service call, such as with a live banking agent (or an automated service), where the customer may want to perform a banking transaction and the agent may be responding to the customer's queries. In such a setting, the back-and-forth conversation between the user, who is a banking client, and the banking agent may ultimately result in the banking agent performing the task desired by the banking client, such as transferring money to another account, sending a wire, updating an account, etc.

In another example, the project may be an online chat between a help-desk support agent, which may be human or a bot, and a customer who is trying to resolve a computer issue. In yet another embodiment, the project may relate to a slack™ conversation between two employees that are trying to work together on an enterprise project. The conversation may also be in any medium, e.g., voice, text, or video, and utilize any type of platform (messaging, social media, chatbots, online, etc.)

Depending on the enterprise and the application, the original set of projects may be hundreds or even thousands of projects. For example, an enterprise may have thousands of tickets received, processed, and closed. Since one of the goals in inputting the projects that are already completed into the LLM is to train the LLM, the number of projects may be narrowed down to a manageable set of projects that represent a sample of all the projects. To perform the narrowing from the large set of projects to the manageable set of projects that represent a sample of all the projects, either the customer or the LLM may provide the factors that are to be used to filter and narrow the larger set. For example, in one embodiment, the large set of projects may be accessed by the LLM to determine a sample size and a sample set of narrowed projects. The LLM may automatically generate factors for narrowing the data set and use those factors, such as similarity of data between projects, similarity of queries in the projects, similarity of responses in the projects, similarity of processes used in the projects to provide the responses, similarities in cost and accuracy of projects, similarity in project being perform for a specific enterprise, similarities of projects that relate to a specific department in the enterprise, whether the projects were conducted by a specific individual which may be an indicator that the projects may be of similar type, and other factors that may be inputted by the LLM, system, or driven by the customer, to narrow down to the manageable set.

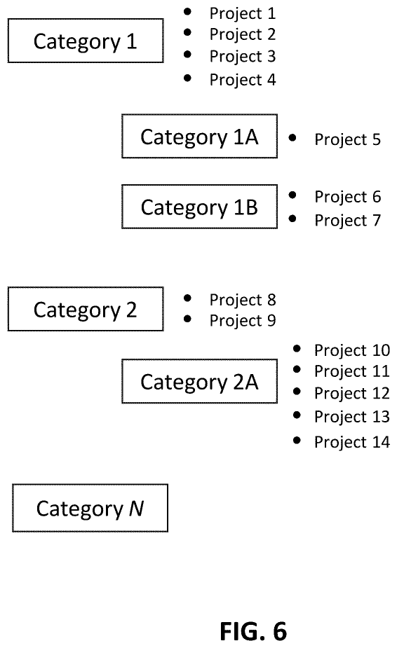

At block 130, in some embodiments, the narrowed set of projects may be clustered/grouped and categorized into groups. The categorization may be by topic, genre, type of problem solved, content and context of the trouble ticket, or any other category inputted by the user or the system, such as the system depicted in FIG. 2. In some embodiments, the LLM may access the narrowed set of projects, analyze them, such as based on the data within the project, and may automatically determine a category that is common between a certain number of projects. For example, after analyzing all the projects, the LLM may be used by the control circuitry, such as control circuitry 200 and/or 228 of system in FIG. 2, to determine that projects 1-4, as depicted in FIG. 6, have a common category, such as category 1. In this example of FIG. 6, the control circuitry 220 and/or 228 may further determine that project 5 falls under a sub-category of category 1A and project 6 and 7 fall under the sub-category of 1B. Likewise, the control circuitry may also determine that projects 8 and 9 fall under category 2, while projects 10-14 fall under sub-category 2A. As such, the control circuitry may leverage the LLM to generate a plurality of categories and subcategories and place, save, or identify the projects with those categories and subcategories. In some embodiments, determining such commonality between projects may require the LLM to perform complex processes and analyze the data to determine similarities and differences between data such that they can be accurately categorized into different categories and subcategories.

In some embodiments, clustering and categorizing of projects may require additional information or an understanding of the lexicon used within the projects. For example, an enterprise may use words that are unique to the enterprise that are not common in the industry or the real world. In another example, the enterprise's use of certain words may be different from common practices. In yet another example, the enterprise may use words in a particular context and knowledge of the context may be needed. As such, in some embodiments, when a determination is made that additional information or context may be needed for clustering and categorization, such data may be obtained from knowledge base 125. The control circuitry leveraging an LLM may determine that data/knowledge is missing and then automatically query the knowledge base to obtain the data. In other embodiments, new data that is not in the knowledge base may be learned though the project, and in such instances, the knowledge base 125 may be updated with the new data.

At block 140, a workflow for each category may be determined. The process may include the control circuitry 220 and/or 228 inputting each categorized project into the LLM or the LLM automatically accessing the categorized project. The embodiment may include the control circuitry 220 and/or 228 inputting one project at a time into the LLM, a plurality of batch of projects at a time into the LLM, or all projects associated with a specific a category, such as category 1, into the LLM. Each project may then be analyzed by the LLM to determine a workflow used, such as by a human, to perform the project. Since the projects inputted at this stage are projects that have already been completed, the workflow determination may be for the purposes of training the LLM and/or determining workflow models used by each project. In other words, by inputting and analyzing the projects, and by determining a workflow for a specific project, the LLM may learn the steps taken by a human agent/operator to perform the task.

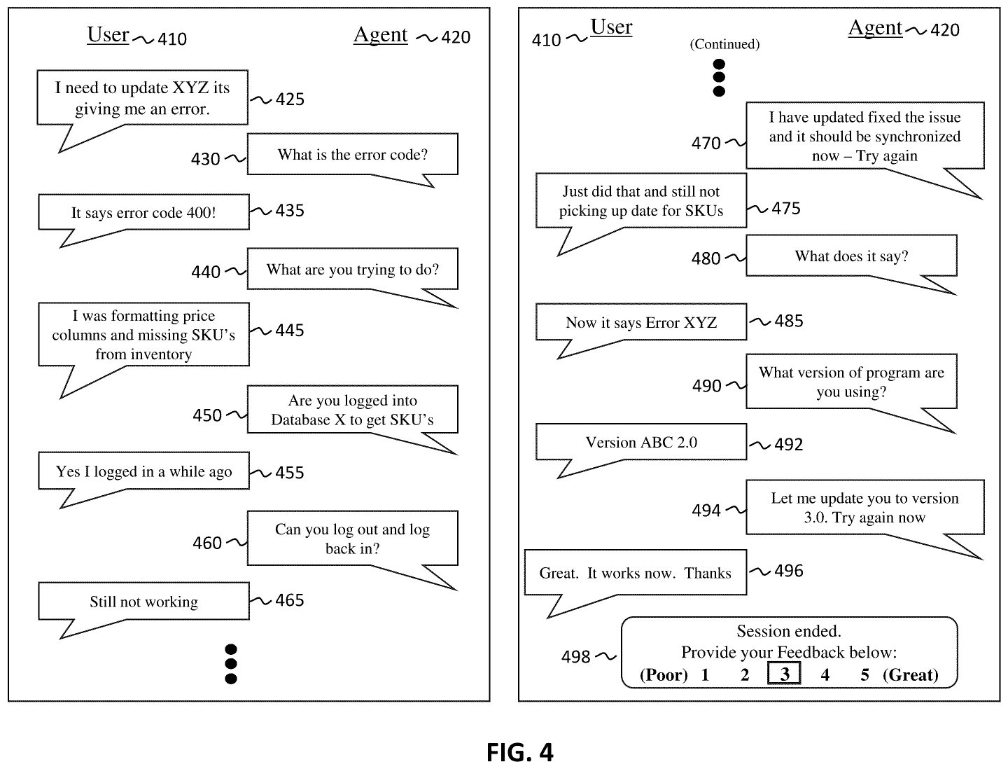

One example of a project in which a human performed a task includes a project depicted in FIG. 4. In this example, a ticket for updating an excel sheet with SKU (stock-keeping unit) numbers, i.e. scannable code associated with each product in an inventory, is submitted. The user, who is having a problem updating their SKU numbers on their excel sheet may have reached out to a human agent 420, such as a customer service agent or someone from the company's IT department who handles such issues.

Although this example involves an online conversation between a user and an agent, the embodiments are not so limited, and any other form of conversation, such as texting (SMS) using a smartphone, online chat, a voice phone call, conversations using a chatbot, or a video conversation between two or more parties is contemplated within the embodiments.

In this example user 410 in FIG. 4 may have been conversing with agent 420 to resolve an issue at the user's end. The conversation between the two (User 410 and Agent 420) may start after a ticket has been submitted and the user initiates the conversation at 425 by indicating that they need to update XYZ and doing so is giving the user an error. This may be an excel sheet that the user is trying to update with SKU numbers.

In response to receiving the user's query at 425, the agent, at 430, may ask the user for further clarification. For example, the agent may ask the user to provide the agent with an error code that has been showing on their side when the user tries to update the XYZ on their side.

At 435, the user may provide the error code, which may be error code 400, in response to the agent's query 430. In response, the agent at 440, may ask the user for further clarification as to what the user was trying to accomplish when they received the error code. The back-and-forth conversation may continue until block 470 when the agent 420 performs some steps on their end, such as looking up the sheet and synchronizing it such that the user is able to obtain the latest SKUs. At that point the agent 420 may ask the user to try updating XYZ again on their end to determine if the issue has been resolved based on the fix attempted by the agent.

As mentioned above, this may be a trouble ticket that has already been resolved, i.e., the conversation may have already occurred, and is being used to train the LLM based on what actually happened during the conversation and what steps were taken to fix the error. As part of the training process, the LLM may analyze each back and forth between the user 410 and agent 420 and determine whether such back and forth translates into a working step. Not every back-and-forth conversational interaction between the user and the agent may result in a workflow step. However, the steps that involve any sort of looking up, agent issuing a fix, agent performing a computation, agent using tools, agent escalating the process to be resolved, such as due to the project, a step or a single back-and-forth conversational piece needing addition skills to provide an answer, or any substantive step such as a step that involves any function performed by the agent may be analyzed and translated into a workflow step.

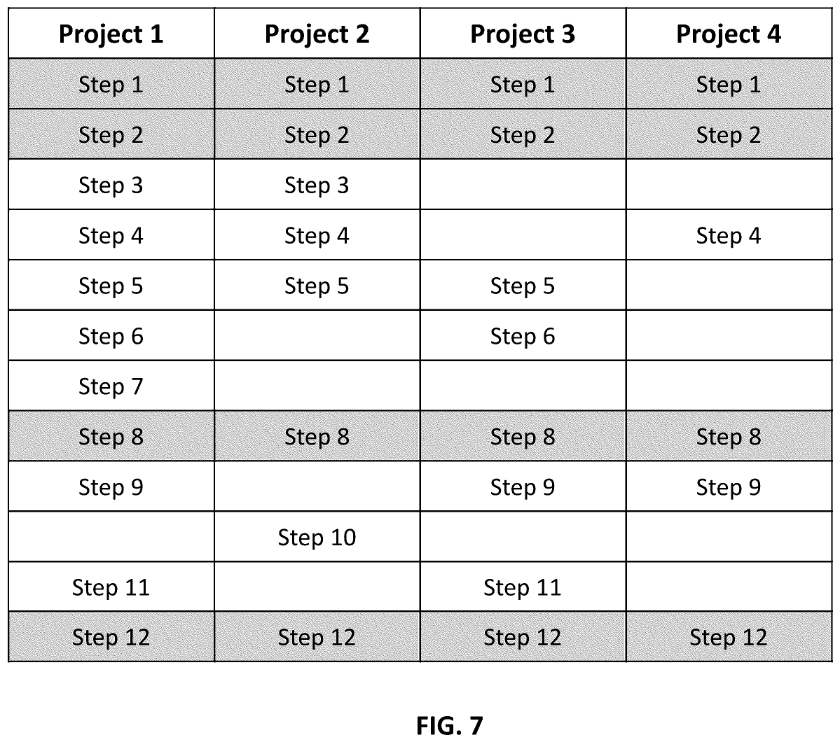

For example, the step of figuring out what is the error code (blocks 430 and 435) and what does that error code mean, i.e. what system function is not being performed due to the error, may be a step performed on the agent side that may be translated into a working step. Likewise, the agent figuring out what is the issue that is causing the lack of synchronization may also be another step performed by the agent that may be used as a workflow step. All such steps may be translated into a workflow step by the LLM after the LLM has analyzed the conversation and a determination is made that the step is either substantive, performs an action or function, or is needed for resolving the user query. The details of a function performed by the agent may also be analyzed to determine whether it should be identified as a step that is part of the workflow used by the agent. In some instances, the step or function performed by the agent may not be obvious and as such the LLM may automatically, based on its training data, determine one or more possible actions that may have been performed and add that as a step to a workflow. Further details relating to generating workflows from conversational input, determining which pieces of conversation and actions performed by the agent are to be translated into workflow steps, which steps can be modified, eliminated, or added to a workflow are described below at least in reference to FIGS. 6-7. Additionally, details relating to generating workflows from conversational input are described in patent Ser. No. 18/610,276 filed on Mar. 20, 2024, which is incorporated in its entirety herein.

In some embodiments, the process of analyzing each project and converting pieces of conversation that are relevant into workflow steps is performed for all the projects that are identified in a narrow set for analysis and are inputted into the LLM. For example, as depicted in FIG. 6, all the projects 1-4 in category 1, may be analyzed and converted into workflows by the LLM.

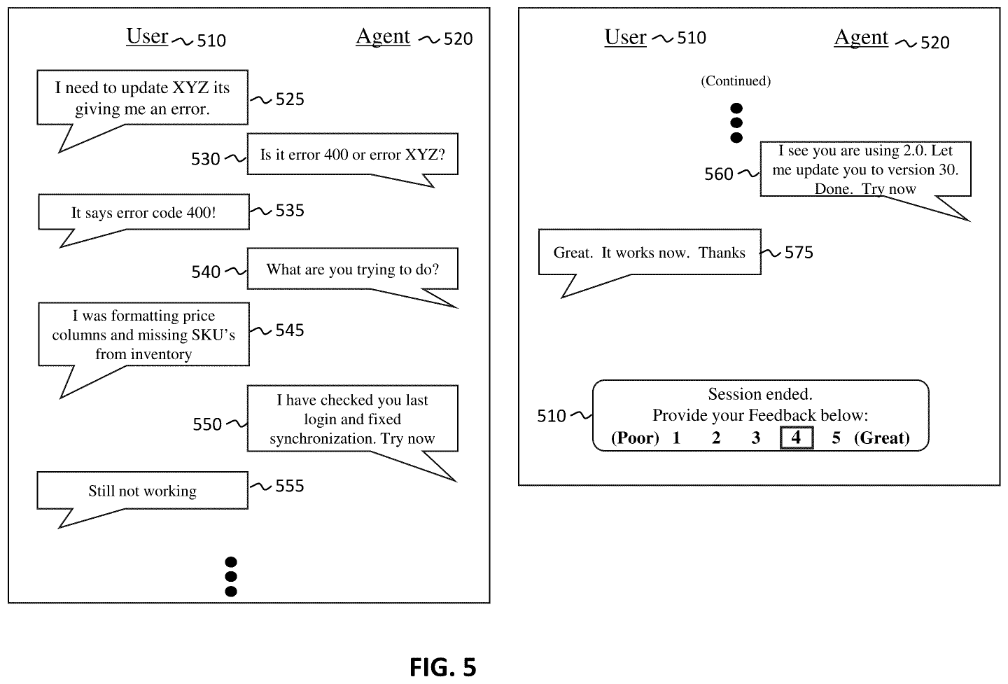

At block 150, the LLM may consolidate workflows and perform optimization of the workflows to generate an optimized workflow. The process of consolidation and optimization may involve the LLM analyzing all the workflow steps of each of the projects identified. The LLM may also remove any redundancies, eliminate any workflow steps, or modify or add any workflow steps, to generate a robust and optimized workflow that is derived from all the workflows analyzed. For example, in some embodiments, two different projects that are depicted in FIGS. 4 and 5, i.e. projects under the same category, may be inputted into the LLM. The LLM may analyze the conversation that occurred in those projects and convert them into workflow steps. Since project in FIG. 4 involves conversations depicted at blocks 425-496 (e.g. 17 back-and-forth conversational steps from 425 to 496), it is likely that the workflow for the project in FIG. 4 may result in larger number of workflow steps than the workflow for project of FIG. 5 which involves lesser steps (e.g. conversation blocks 525-575, which amount to 9 back and forth conversational steps). In other words, project 5 (9 conversational steps), which is a reduction from project 4 (17 conversational steps) may be associated with lesser workflow steps to accomplish the same or similar result as the response and result in project 5. Although the number of conversations steps are not equivalent to the number of workflow steps, as discussed above, the LLM may determine that the manner in which project 4 was handled by the agent may involve some redundant steps that can be eliminated to generate a consolidated optimized workflow that takes the best from both projects 4 and 5 and removes redundancies to generate the optimized workflow.

In some embodiments, the LLM may analyze all the workflow steps from all the projects based on a plurality of factors to determine how to generate the optimized and consolidated workflow. Several non-limiting techniques as described further in FIGS. 7-11 may be used in that regard. In one embodiment, as depicted in FIG. 7, the workflow steps of each project, such as projects 1-4 under category 1, as depicted in FIG. 6, may be analyzed to generate a consolidated and optimized workflow. In this embodiment, the LLM may determine common workflow steps between all the projects 1-4. The LLM may also determine which workflow steps are unique to certain projects. For example, based on the analysis, as depicted in FIG. 7, the LLM may determine that steps 1 and 2 are common to all the four projects while step 7 is only performed in project 1 and no other projects analyzed under the same category. As such, the LLM may determine that step 7 is potentially a redundant step that can be eliminated. The LLM may test that hypothesis to ensure that eliminating step 7 would not cause a difference in the outcome/result, or if it does, the difference is minimal or below a predetermined threshold. Based on further analysis, if a determination is made that step 7 is redundant, then the LLM may eliminate step 7 from a consolidated and optimized model generated.

Accordingly, the LLM may analyze a plurality of workflow from each project to determine redundancies and areas of optimization and generate the optimized workflow. The process may not necessarily involve retaining workflow steps in the consolidated and optimized workflow that are common to all projects or eliminating workflow steps that are not used by any of the projects. In other words, the analysis may not necessarily be a 1:1 analysis of whether the workflow step is performed or not to determine its inclusion in the optimized workflow. The LLM may utilize deep learning to determine the final steps in the consolidated and optimized model, such as by applying some of the factors and techniques described in FIGS. 7-11. For example, even if certain workflow steps are used by all the projects, the LLM may determine that 2-3 steps from the workflow may be consolidated by using a different technique or approach. For example, in responding to queries in the projects 1-4, the agents may not have used certain techniques that could have been used to resolve some portion of the problem. In another example, in responding to queries in the projects 1-4, the agents may have escalated certain issues to engineers or other departments to be resolved, the workflows involved in such escalations may automatically be performed by an LLM without having to do such an escalation. In yet another example, in responding to queries in the projects 1-4, the agents may have proposed escalation for a step when escalation capabilities may not be available, LLMs may check all capabilities before proceeding down a path that may require capabilities that the system does not have and accordingly suggest different paths. As such, the LLM may apply a different solution that consolidates or replaces a few steps from the workflows to then use the new solution in the optimized workflow.

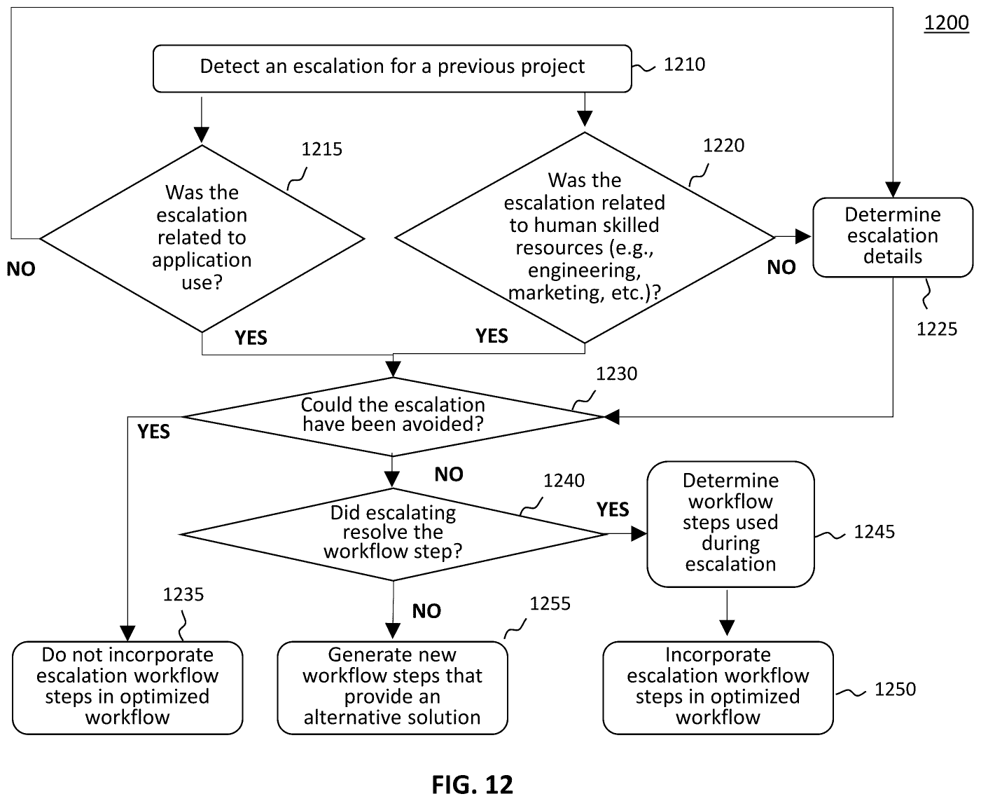

At block 160, the LLM may be trained using the optimized workflow. Once trained. It may be tested to determine if further revisions or training of the LLM is needed. The testing may be performed on already completed projects to determine how the LLM trained with the optimized workflow responds in comparison to how an agent has already responded to a user while responding to a user query. Further training may be provided if the LLM's response deviates from what the agent already responded to in the project. In some embodiments, further training may be performed only if the deviation is above a predetermined threshold, e.g. LLM response deviates with the agent response by more than 15%, etc. Further training may also be provided if the LLM's response deviates from a predetermined response, an industry accepted response, or a response provided by the enterprise previously for the same or similar query. In some scenarios, although the LLM response may deviate from the agent response, it may still be within a threshold of predetermined response, an industry accepted response, or a response provided by the enterprise previously for the same or similar query. In such scenarios, where LLM response may be acceptable even when deviated from the agent, further LLM training may not be needed. Further details associated with training and revising the LLM are described in relation to FIGS. 12-14.

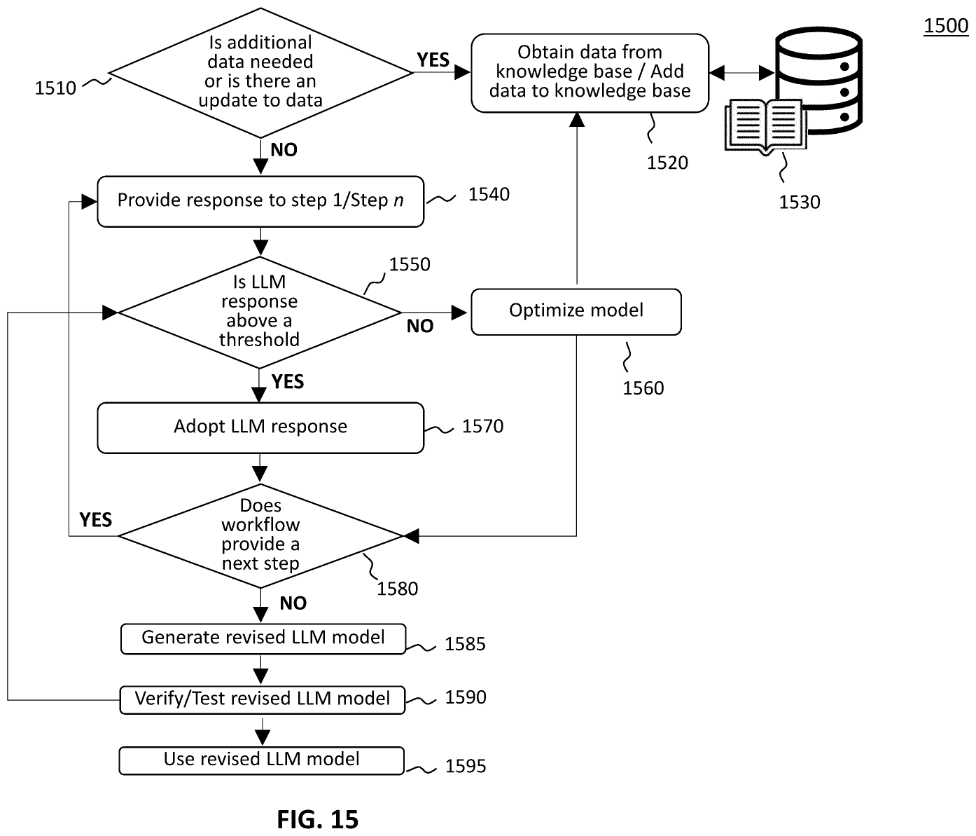

At block 170, once the LLM has been trained, and workflow to be used by the LLM has been optimized, the LLM with the optimized workflow may be made ready to handle live projects, as depicted at FIG. 15. Any feedback received in handling the live projects may be fed back into the LLM as a constant feedback loop to continuously update the optimized workflow for responding to queries and solving problems for issues for projects in its category. In some embodiments, the workflows may be once again verified and tested and any improvements may be made prior to using them for responding to queries and solving problems for issues for projects in its category. The workflows may also be made dynamic by optimizing one or more workflow steps as more and more projects are handled or if data used in the workflow steps changes.

FIG. 2 is a block diagram of an example of a system for generating generate category specific workflows by leveraging one or more LLMs and providing them to use in a live conversational environment, in accordance with some embodiments of the disclosure and FIG. 3 is a block diagram of an example of an electronic device for using LLMs and generated and/or optimized workflows and LLM to respond to queries, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4-16. Further, FIGS. 2 and 3 may also be used to access remote applications, receive or access a plurality of projects, cluster and categorize the received or accessed plurality of projects into groups, use various factors to cluster projects, such as determining similarity of queries, problems to be solved or attributes in the plurality of projects, determine a workflow for all the categorized projects, consolidate workflows and perform optimization of workflows to generate an optimized workflow, perform optimization based on one or more optimization factors, determine whether to include escalations in the optimized model, test optimized workflow, including testing to compare the responses provided by using the optimized workflow with responses provided by an agent in an already completed project, further optimize workflow based on testing results, use the revised and optimized model to handle live projects, such as like tickets, continuously improve the workflow based on feedback received and learnings from applying the optimized workflow to live projects, utilize LLMs, utilize machine learning and AI algorithms, and perform all embodiments disclosed herein.

In some embodiments, one or more parts of, or the entirety of system 200, may be configured as a system implementing various features, processes, functionalities and components of FIGS. 1 and 4-16. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. In some embodiments, the system may be a generative artificial intelligence system that leverages LLMs. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 and instead such functionality may be implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as user device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, or any other suitable fixed or removable storage devices, and/or any combination of the same. Each storage 224, 238 may be used to store various types of data (e.g., they can be used to store plurality of projects, samplings of projects accessed, grouping of projects, categories of grouping, workflows, optimization and clustering factors, optimized workflows, LLMs, scores for responses provided by LLMs using the optimized workflow, a knowledge base, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to plurality of projects, samplings of projects accessed, grouping of projects, categories of grouping, workflows, optimization and clustering factors, optimized workflows, LLMs, scores for responses provided by LLMs using the optimized workflow, a knowledge base, and NLP, ML, and AI algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received, such as from an application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response detecting redundancies in a workflow, analyzing the redundancy and if the step(s) are not needed, not including the redundant steps from the workflow into the optimized workflow. To accomplish this, in one embodiment, the control circuitry 228 may perform the steps of process described at least in any one or more of FIGS. 1 and 4-16 and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive data such as data relating to plurality of projects, samplings of projects accessed, grouping of projects, categories of grouping, workflows, optimization and clustering factors, optimized workflows, LLMs scores for responses provided by LLMs using the optimized workflow, knowledge base, and NLP, ML, and AI algorithms.

Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be a personal computer (PC), a laptop computer, a tablet computer, a personal computer television (PC/TV), a generative AI server, a handheld computer, a mobile telephone, a smartphone, or any other device, computing equipment, or wireless device, and/or combination thereof that can receive conversation inputs and process them to generate workflows as discussed.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors or Nvidia processors) or multiple different processors (e.g., an Intel Core i7 and i9 processors or Nvidia GH 100, 200).

In some embodiments, control circuitry 220 and/or control circuitry 218 are configured to access remote applications, receive or access a plurality of projects, cluster and categorize the received or accessed plurality of projects into groups, use various factors to cluster projects, such as determining similarity of queries, problems to be solved or attributes in the plurality of projects, determine a workflow for all the categorized projects, consolidate workflows and perform optimization of workflows to generate an optimized workflow, perform optimization based on one or more optimization factors, determine whether to include escalations in the optimized model, test optimized workflow, including testing to compare the responses provided by using the optimized workflow with responses provided by an agent in an already completed project, further optimize workflow based on testing results, use the revised and optimized model to handle live projects, such as like tickets, continuously improve the workflow based on feedback received and learnings from applying the optimized workflow to live projects, utilize LLMs, utilize machine learning and AI algorithms, and performing all the functions, steps, features, discussed herein. Control circuitry 220 and/or control circuitry 218 are also configured to perform all processes described and shown in connection with FIGS. 1, 10-12, and 15-16.

Computing device 218 receives a user input 204 at input circuitry 216. For example, computing device 218 may receive a user input like “I need to update XYZ its giving me an error,” as depicted at 425 in FIG. 4.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 10-12, and 15-16, respectively.

FIG. 3 is a block diagram of an example of an electronic device 300 used to provide an input user messages in a conversation with an agent, enter queries, receive responses from an agent, and execute workflows to receive an answer or solution to the queries. The electronic device 300, in some embodiments, may also be used to access remote applications, receive or access a plurality of projects, cluster and categorize the received or accessed plurality of projects into groups, use various factors to cluster projects, such as determining similarity of queries, problems to be solved or attributes in the plurality of projects, determine a workflow for all the categorized projects, consolidate workflows and perform optimization of workflows to generate an optimized workflow, perform optimization based on one or more optimization factors, determine whether to include escalations in the optimized model, test optimized workflow, including testing to compare the responses provided by using the optimized workflow with responses provided by an agent in an already completed project, further optimize workflow based on testing results, use the revised and optimized model to handle live projects, such as like tickets, continuously improve the workflow based on feedback received and learnings from applying the optimized workflow to live projects, utilize LLMs, utilize machine learning and AI algorithms, and perform all embodiments disclosed herein.

In an embodiment, the equipment device 300, is the same equipment device 202 of FIG. 2. The equipment device 300 may receive content and data via input/output (I/O) path 302. The I/O path 302 may provide audio content and data to control circuitry 304, which includes processing circuitry 306 and a storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 or Nvidia processors) or multiple different processors (e.g., an Intel Core i5, i7, 19 processor, Nvidia GH 100, 200).

The processes as described herein may be implemented in or supported by any suitable software, hardware, or combination thereof. They may also be implemented on user equipment, on remote servers, or across both.

In client-server-based embodiments, the control circuitry 304 may include communications circuitry suitable to access remote applications, receive or access a plurality of projects, cluster and categorize the received or accessed plurality of projects into groups, use various factors to cluster projects, such as determining similarity of queries, problems to be solved or attributes in the plurality of projects, determine a workflow for all the categorized projects, consolidate workflows and perform optimization of workflows to generate an optimized workflow, perform optimization based on one or more optimization factors, determine whether to include escalations in the optimized model, test optimized workflow, including testing to compare the responses provided by using the optimized workflow with responses provided by an agent in an already completed project, further optimize workflow based on testing results, use the revised and optimized model to handle live projects, such as like tickets, continuously improve the workflow based on feedback received and learnings from applying the optimized workflow to live projects, utilize LLMs, utilize machine learning and AI algorithms, and perform all embodiments disclosed herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store plurality of projects, samplings of projects accessed, grouping of projects, categories of grouping, workflows, optimization and clustering factors, optimized workflows, LLMs, scores for responses provided by LLMs using the optimized workflow, a knowledge base, and NLP, ML, and AI algorithms. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The microphone 316 may be used by control circuitry 304 to receive audio input. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to leveraging and executing LLM models, implementing machine learning (ML) and artificial intelligence (AI) algorithms, and all the functionalities discussed associated with the figures mentioned in this application

The electronic device 300 of any other type of suitable user equipment may also be used to implement ML and AI algorithms, and related functions and processes as described herein. Various network configurations of devices may be implemented and are discussed in more detail below.

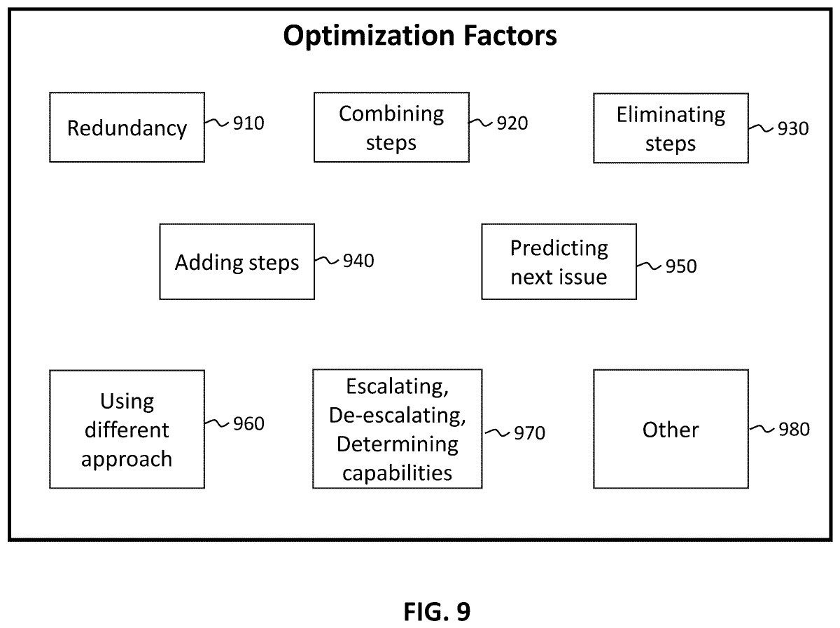

FIG. 4 is a block diagram of a first example of a ticket that includes a conversation between a user and an agent, in accordance with some embodiments of the disclosure. In this figure, a back-and-forth conversation takes place between a user 410 and an agent 420. This back-and-forth conversation may be part of a project, such as a trouble ticket, that was submitted by the user and is now closed. In some embodiments, a ticket which is already handled by a human agent and closed may be inputted into an LLM for the purposes of understanding how a live human agent had actually handled a user ticket for a specific category. Such data may be inputted into the LLM to train the LLM on a human process used for answering a particular category of ticket. Although such steps will not be copied directly, since each project, e.g. a trouble ticket, is different and has various different components that need to be analyzed to solve it, the already completed projects and the workflow used by the agents may be used as guidance. Once the workflows are obtained, deep learning techniques may be applied to further enhance the workflows and make them more efficient, robust, and optimized, such that the newer workflow generated from it by the LLM may be used to handle live tickets. The process of obtaining the more efficient, robust, and optimized workflow from the inputted workflow may involve several complex processes, computations, and analyses. Some of the optimization factors that may be used to do so are described in FIG. 9.

Referring to the conversation in FIG. 4, the back-and-forth conversation relates to a user trying to update something, e.g., XYZ, on their side, such as in an excel sheet, and when the user attempted to do so, the system, displayed an error preventing the user from accomplishing the updated XYZ. The conversation with the agent that subsequently unfolded as part of a trouble ticket submitted by the user includes the agent asking for the type of error that's being shown to the user. The agent may ask such preliminary questions to understand the nature of the error and then determine next steps to solve the error. In some embodiment, the trouble ticket may include the error, however, the agent may still have asked the question to confirm it with the user or to ask for clarifying details.

As the conversation progressed in the previously completed project, the agent had discovered, at 445, that the user was trying to format price columns and they were missing SKUs from the inventory. As such the agent had decided to ask follow-up questions relating to whether the user is logged into database X and whether logging in and out solved the error, as depicted at 465. Subsequently, the agent had tried to synchronize the database such that the SKUs can be automatically updated. At blocks 485-492, the agent further discovered that, aside from the synchronization fix at block 470, the user may have also been running an old version of the software program (as depicted at block 492). As such, the agent had updated the user software version to ABC 3.0 from the older version ABC 2.0 that the user was using. When such a ticket that has been already handled is inputted into an LLM, the LLM may analyze the conversation to determine errors caused by the agent, redundancies in the agent's approach, steps that could be eliminated, different alternative approaches that could have been used, and methods to make the conversation more efficient. For example, the LLM, based on its training data from a plurality of similar project, may determine that once error code 400 is determined that other related issues such as missing SKUs from the inventory, logging into database X, synchronization error, software version update, should have been determined without having to ask follow-up questions to the user since the related issues may have been associated with error 400. As such, some portions of the conversation could have been bypassed to reach the solution in a more efficient manner.

FIG. 5 is a block diagram of a second example of a ticket that includes a conversation between a user and an agent, in accordance with some embodiments of the disclosure. Similar to FIG. 4, in FIG. 5, user 510 and agent 510 engage in a similar conversation trying to solve a same error, error 400, that has been discovered in a different trouble project, e.g., trouble ticket. In this back-and-forth conversation, agent 520 is able to resolve the issue in a lot fewer steps than the agent in FIG. 4. In FIG. 5, agent 520 based on the error code 400 asked a question about synchronization and then determined that both synchronization and a version of software needs to be updated (at blocks 550 and 560). By doing so, the agent in FIG. 5 eliminated a plurality of steps that were taken by agent in FIG. 4 to solve a project with the same error code 400 and limited the back-and-forth conversation from seventeen conversation steps in FIG. 4 to nine conversation steps in FIG. 5. Both workflows of FIG. 4 and FIG. 5 may be inputted into an LLM for analysis, and the LLM may analyze them based on each project's content to then apply one or more of the optimization factors as depicted in FIG. 9 for generating a revised and refined new workflow.

FIG. 6 is a block diagram of categorization of projects, such as by using an LLM, in accordance with some embodiments of the disclosure. In some embodiments, an LLM may categorize all the projects received into a plurality of categories. As described earlier, these projects may be related to trouble tickets or any other type of project in an enterprise. The plurality of categories may include a broad level category as well as nested deeper level categories. For example, category 1 may include deeper subcategories 1A and 1B. Likewise category 2 may include a sub category 2A. The higher-level category may be related to a broader topic while a sub category may be related to a niche topic within the broader category. For example, if category 1 relates to login problems, category 1A may be related to the login problem that are specific to logging into a certain database.

The process of categorizing each project may involve an LLM using deep learning techniques to analyze the project and associate it with a category, such a s based on a specific genre, topic, sub-topic, or some other commonality between the projects. In one embodiment, categorization may involve the LLM analyzing its keywords of each project in context to determine which category the project should be categorized under. In another embodiment, the LLM may receive guidance from a knowledge base to understand the terminology of each project such that the projects can be accurately categorized. For example, a specific term, an error code, user job function, etc., may be a common attribute between the projects that may be analyzed by the LLM for them to be categorized under one category. In yet other embodiment, keywords alone may not be representative of the category and as such contextual understanding, pairing of words, analyzing of type of language or error codes within the project, and other user provided input may be performed and analyzed to categorize each project. In another embodiment, when the keywords that are descriptive of the category are missing or differ from project to project, then the LLM may analyze various portions of the project to contextually determine common attributes between projects and categories to which the project should be assigned. Such contextual determination may involve deep learning and using various formulas to determine similarity in projects. Once the projects have been categorized, such as based on similarity of at least one attribute, projects that are similar may be clustered together. In some embodiments, a rule may be established for a certain number of attributes, certain number or type of keywords or functions to be common between the projects for the projects to be categorized under the same category.

As it can be seen in FIG. 6, based on an LLM analysis, projects 1-4 may be categorized under category 1, project 5 may be categorized in a subcategory 1A and projects 6 and 7 may be sub categorized under category 1B. All the projects within a category or within a subcategory may share one or more common attributes. For example, projects 1-4 may share a common attribute of the users not being able to login into their system. In another example, projects 1-4 may share a common attribute where the user is not able to synchronize their excel sheet to get updated sales information.

In some embodiments, each project may be categorized under a single category while in other embodiments, a project may be categorized under multiple categories and sub categories.

FIG. 7 is a block diagram of workflows associated with separate projects from the same category, in accordance with some embodiments of the disclosure. In some embodiments, workflows of each project completed may be obtained, such workflows of projects in FIGS. 4, 5, and 6 that are associated with category 1. Once the workflows are obtained, they may be analyzed based on optimization factors described in FIG. 9. Referring to FIG. 9, it is a block diagram of optimization options used to optimize a workflow that is to be used in a conversational environment, in accordance with some embodiments of the disclosure. Some of the optimization factors used may include, redundancy 910, combining steps 920, eliminating steps 930, adding steps 940, predicting the next issue 950, using a different approach 960, escalating, deescalating and/or determining capabilities 970, or any combination thereof.

With respect to redundancy, one or more other projects (such as projects 1-4 of FIG. that fall under the same category 1) may have used additional steps, processes, or computations that may not be necessary to perform the workflow step, the workflow overall, or to achieve the same or similar end result. For example, in some instances, an actual ticket that has been handled (such as projects 1-4) may have used steps or certain back and forth exchanges of information or conversations that could have been bypassed. For example, referring to FIG. 7, project 1 includes a step 7 that is not performed by other agents in projects 2-4. Likewise, project 2 includes step 10 which was not performed by agents in other projects 1, 3-4. As such, a determination may be made for steps 7 and 10 to be evaluated for redundancy. The steps may not be simply eliminated just because they were used in one project and not another project, from the group of projects analyzed and under the same category. A deeper analysis using deep learning may be used by an LLM to determine their need, i.e. the need for a specific workflow step. Further, the LLM may analyze step 7 and step 10 in context of the overall workflow for their specific projects and determine whether such a step is necessary to perform the overall workflow and achieve a same or similar result in step 12. In some embodiments, the LLM may determine that steps 7 and 10, which are not performed in other projects, are redundant. Once a deeper analysis is done of the steps 7 and 10 in context with their individual workflows of each project, the LLM may determine, in one embodiment, that step 7 and/or 10 are redundant and that a same or similar final result in the workflow may have been achieved without steps 7 and/or 10. As such, in a final optimized workflow that is to be generated, which is based at least in part on workflows used in previous projects (e.g. Projects 1-4), the LLM may eliminate steps 7 and 10 from the final workflow if a determination is made that such steps are redundant. In other embodiments the LLM may determine that the other projects should have performed steps 7 and 10 and those steps are missing from the other projects. As such, the LLM may retain steps 7 and/or 10 in the final optimized workflow that is to be generated and used in a live and real-time environment, such as for handling live problem tickets.

With respect to combining steps 920, the LLM may make a determination whether one or more steps within each workflow can be combined. For example, if a particular error code exists, such as error code 400 depicted in FIGS. 4 and 5, and a follow-up with a user was performed (such as follow up conversations 440-492), to limit the amount of back and forth, a determination may be made to ask multiple questions at the same time to determine which path to take in the workflow. In other examples, when a determination is made that a certain error code exists, the LLM may automatically determine which processes, including any downstream processes, are to be performed without having to query the user or determine whether such processes need to be performed. As such, steps associated with some of the back and forth that occurred in a previous project may be combined into one step (or lesser steps). For example, referring to FIGS. 4 and 5, the LLM may determine that because error code 400 occurred, other errors that may be experienced downstream may include access to database X (as described at block 450), synchronization of files (as described at block 470), and updating to a latest version of software (as described at block 490-492), could have been anticipated and such processes errors may have been checked without involving the user. In some embodiments, there may be several instances in each project, such as projects 1-4, for combining certain workflow steps. If and when such opportunities exist, the LLM in generating a final optimized workflow that can be used for handling live projects, such as live tickets, may combine certain steps to further optimize the workflow.

With respect to eliminating steps 930, similar to combining steps and redundancy evaluations, in some embodiments, the LLM may determine that certain steps are simply not needed or can be bypassed and as such eliminate those steps in the final workflow that is to be generated for handling live projects.

Likewise, with respect to adding steps 940 to the final optimized workflow, in some embodiments, the LLM may determine that certain steps that do not exist in one of the workflows or any of the workflows can be added. The LLM may determine that by adding such additional steps, other steps in the workflow may be bypassed or eliminated. The LLM may also determine that by adding such additional steps, the process may be made more efficient, may use lesser computing resources, may cost less, or may provide a result that higher in accuracy.

With the respective predicting the next issue 950, the LLM may determine whether a particular error leads down the path of a certain sequence of steps that need to be performed. In other words, because a certain error exists, the likelihood of one or more other elements that may have gone wrong may also exist and as such in order to correct the root error, the other one or more downstream issues may also need to be corrected. Based on leveraging the knowledge base and learnings from other projects, the LLM may predict such next issues and optimize the workflow to handle not only the current issue described by the user, but also to check any potential downstream related issues or error that may arise. As such, the LLM may add steps to address a potential issue that may be found later down the path that are related to the initial issue or error code. The LLM may also design sub-workflows that execute multiple steps simultaneously to determine any downstream issues or errors to make the workflow more efficient. For example, while executing a main workflow, the LLM may also design and execute a second workflow to determine whether solving a particular problem in the main workflow, if an issue or longer path to solution may be involved downstream. If the second workflow result indicates that a certain issue may be cause, the LLM may revise the main workflow based on the results obtained from the simultaneously executed second workflow such that a different path or step is used to avoid the downstream issue.

In some embodiments, as depicted at 960, the LLM may use a different approach to handle one or more steps of the workflow. For example, a determination may be made that instead of selecting process A, process B, which takes a different approach (such as different processes, different computations, different strategies, etc.) may be used to bypass certain steps or add certain steps to the workflow used but by doing so may make the overall workflow more robust and efficient. As such, the LLM may leverage other techniques, strategies, processes to determine how to optimize, and when to optimize a workflow obtained from previous projects, to then generate the new optimized workflow that uses a different approach.

In some embodiments, as depicted at 970, the agent handling a project (such as a ticket in any of the projects 1-4 [not shown in Figures]) may have escalated an issue to be handled. For example, the agent may have escalated to a different team within the organization, such as the engineering team, marketing team, finance team, or some other team that is more skilled in handling a specific step of the workflow. For example, a computation that is finance related may need to be performed and the individual with knowledge and skill to perform such a calculation may be in the finance department. In another example, a discount code may need to be approved by a supervisor, and as such an escalation to the supervisor may have been made when the agent handled the project. In yet another example, some code may have to be written to perform a function for a step of the workflow, and as such the agent may have escalated the issue to the software engineering team for writing the code. In some embodiments the agent may have escalated one or more steps of the workflow by using an external application. Such external applications may be used for any purpose, such as using an external application to perform a calculation, to achieve a particular result, to leverage the skills and capabilities of an external application that is not available internally, such as a Salesforce application. The escalation may be to utilize human skills, automated systems, applications, or other workflows that are external to skills, systems, applications used in the current workflow. In generating the newer and final optimized workflow that is based on an analysis of all the workflows, such as the workflows for projects 1-4, the LLM may also analyze whether such escalation was necessary and if so what workflow, workflow steps, or skilled capabilities and applications were used during the escalation that can be incorporated into the final optimized workflow. The LLM may also determine whether capabilities for making such an escalation are available. For example, the enterprise may not include someone in the engineering team that is skilled to handle such an issue and as such escalating to the engineering department may cause delays and still result in not being able to solve the problem involved in the workflow step when escalated. In another example, the enterprise may not have capabilities of performing the escalation, such as they may not have a subscription to a particular external application that the agent was trying to escalate to for performing the workflow step. The LLM may analyze the capabilities both from a resource, computational, availability, and cost perspective to determine whether such capabilities are available and cost effective before adopting any escalation that was performed in the previously handled ticket into the new optimized workflow. If a determination is made that escalation is not possible, the LLM may offer alternative strategies and workflows steps that can be incorporated into the optimized workflow, which may provide the same or similar solution. The LLM may also display an alert indicating that such an escalation is not available. If a determination is made that escalation is possible, the LLM may adopt the workflows involved during the escalation into the current new optimized workflow such that the overall project can be handled without having to escalate. In some embodiments, the LLM may curate the steps used in escalation before adopting them into the optimized workflow.

In some embodiments, once the already completed projects are analyzed, and various optimization factors as depicted in FIG. 9 have been evaluated, a final workflow, which is a new optimized workflow may be generated. The optimized workflow may include some steps of the workflows from already completed projects (such as projects 1-4) but overall be optimized based on at least the factors from FIG. 9. Any additional optimization factors may also be included as desired. If new optimization factors are added, they may be saved and used for subsequent workflow analysis.

Although the optimized workflow is based on completed projects and the workflows used in the completed projects, it does not necessarily involve copying workflow steps from already performed projects, or eliminating steps that were not common to all projects. In other words, the analysis may not necessarily be a 1:1 analysis of whether the workflow step from already performed projects is to be included or not in the optimized workflow. Instead, the LLM may utilize deep learning and perform various type of analyses to determine the final steps in the optimized workflow and may utilize the previous projects more as training material based on which, at least in part, the optimized workflow is generated.

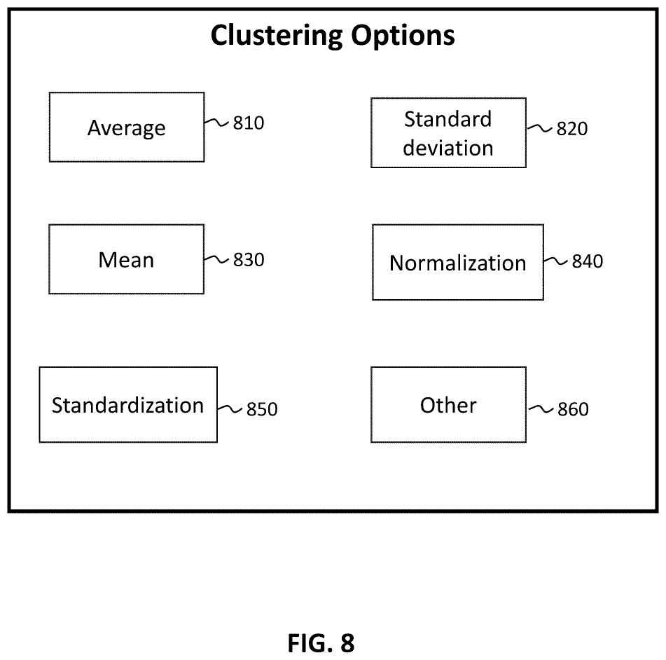

FIG. 8 is a block diagram of clustering options used to cluster steps of workflows used by separate projects that belong to a same category, in accordance with some embodiments of the disclosure. The clustering options, in some embodiments, may include taking an average 810, applying standard deviation 820, taking a mean 830, normalizing data and workflow steps 840, using standardization techniques 850, and adding any other clustering options 860, including combining various clustering options 810-850. Applying these clustering options, an LLM may determine which workforce steps to include in the optimized workflow. For example, referring to FIG. 7, although a particular step may not be taken by all of the projects, such as step 5 of projects 1-3 not taken in project 4, the LLM may determine that an average number of projects had performed step 5 in the workflow in order to obtain their final solutions in step 12. As such, based on the averages, the LLM may adopt step 5 into the optimized workflow. Similarly, other techniques described in blocks 820-850 may be utilized for clustering workflow steps and including and using them in the optimized workflow. As described earlier, in some embodiments, clustering workflow steps may not necessarily be a 1:1 analysis, such as adopt workflow step 5 because the average number of projects used it, but instead may be deeply rooted in logic, such as by utilizing deep learning, to determine various clustering.

FIG. 9 is a block diagram of optimization factors used to optimize a workflow that is to be used in a conversational environment for handling live projects, in accordance with some embodiments of the disclosure. Descriptions relating to FIG. 9 have been provided above in the descriptions related to FIGS. 4-7. In addition to the description provided, other optimization factors 980 may be generated in an IFTTT (if this then that) format where certain optimizations may be performed by the LLM for the new optimized workflow based on conditions (IF) observed in the previously performed projects. For example, if a project experienced a 2^{nd} error following the first error, and the second error was fixed using a workflow step, then the IFTTT rule for the optimized workflow may be to automatically generate the step for solving the second error if such a first error occurs. The LLM may also generate optimization factors on its own and store them in memory to be used for subsequent optimizations of the workflows based on learning and feedback in handling live projects using the optimized workflow. As such, optimizations may be constantly performed to continuously improve the optimized workflow such that an enhanced and optimized workflow dynamically evolves over time to perform at a higher level.

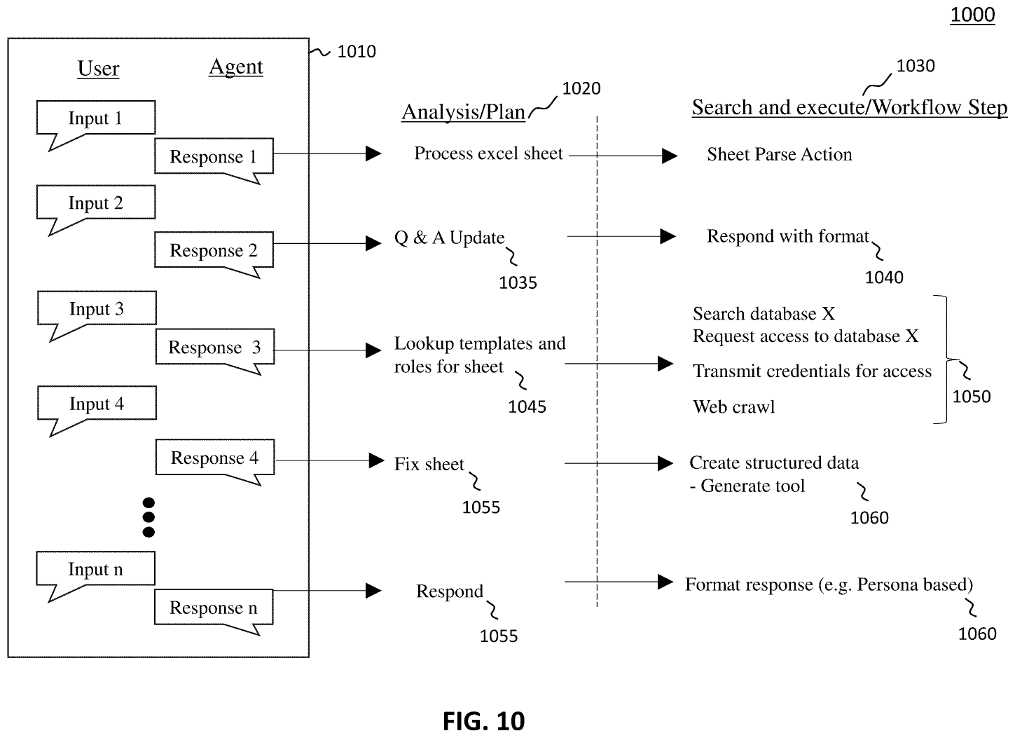

FIG. 10 is a flowchart of an example of a process 1000 for generating and executing a search and execute plan for providing a response in a live conversational environment, in accordance with some embodiments of the disclosure. The process 1000, as depicted in FIG. 1, may be implemented, in whole or in part, by systems or devices such as those shown in FIGS. 2-3. One or more actions of the process 1000 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 1000.

In some embodiments, since the back-and-forth conversation between a user and an agent, as depicted at 1010, may be an ongoing conversation based on which an agent in a previous project may have taken certain steps, such steps, as well as actions involved in completing those steps may be analyzed and documented by the LLM such that such steps and actions involved may be evaluated for being used in the optimized workflow described in FIGS. 7 and 9.

In some embodiments, a) each back and forth piece of conversation, b) a group of back-and-forth pieces of conversation, or c) some of the back-and-forth pieces of conversations, between the user and agent may translate to a workflow step. The LLM may analyze the conversation to determine which conversational pieces justify generating a workflow step. For example, some conversational interactions may be casual conversations, other conversational interactions may involve the agent talking to someone else, yet other conversational interactions may involve the agent or user talking about something unrelated, or may be a piece of conversation that does not require processing or steps to provide an answer.

In some embodiments, a piece of conversation, such as the conversation at input 1 and response 1 at block 1010 may be analyzed. Based on the analysis, a determination may be made that an excel sheet needs to be processed. As such the processing of the excel sheet may be identified in the analysis/action plan 1020. The LLM may also determine that the workflow step required to perform the processing of the excel sheet may be to use a sheet parse action.

Likewise input 2 and response 2 may be analyzed. Based on the analyses, a determination may be made that a Q&A update, as depicted at 1035, needs to be provided to the user. Accordingly, LLM may determine that a workflow step needs to be generated to respond to the user in a format suitable for the user. As such, the workflow step generated may be to respond with a certain format 1040 (and be identified under the search and execute/workflow step 1030 function).

In yet another example, input 3 and response 3 may be analyzed as a function to perform a lookup template and determine roles for the sheet. Accordingly, the LLM may determine a plurality of workflow steps 1050 need to be generated to fully address such a look up. These steps may include searching database acts, requesting action to database acts, transmitting credentials for access, and then performing a web crawl to obtain any data that is still needed which is not available in database X.

The LLM may analyze each previous project completed, such as projects 1-4, and convert relevant conversation pieces into analysis/plan and then workflow steps such that the generated workflow steps may be used to train the LLM for handling a new and live project, such as a live ticket. As explained earlier, the workflow steps generated for previous projects are only used as training data, in some embodiments, and whether to adopt a specific step from the workflow may be based on categorization and optimization factors described in FIGS. 8 and 9.

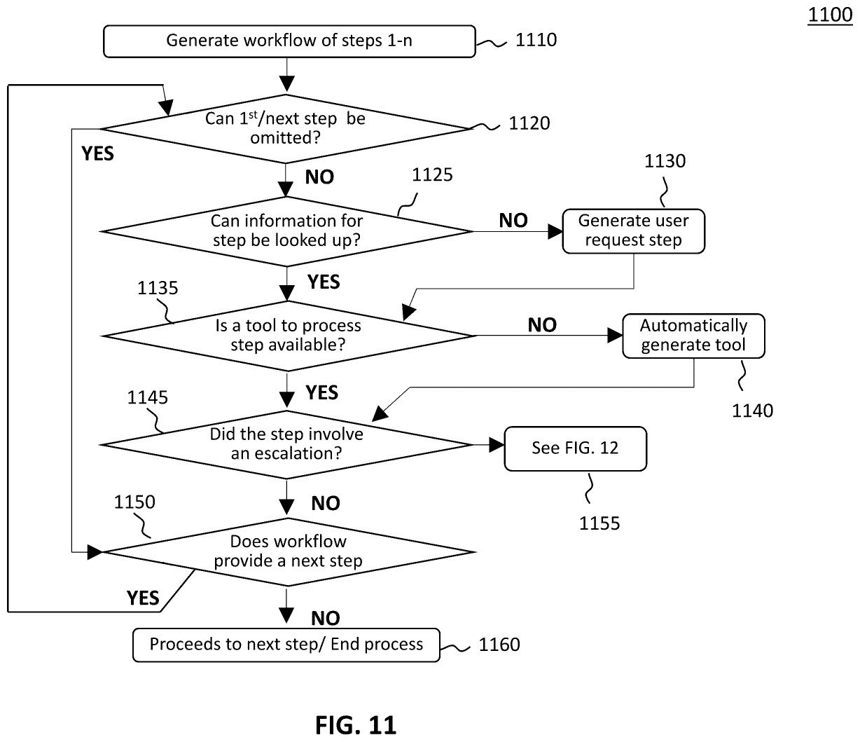

FIG. 11 is a flowchart of an example of a process 1100 for optimizing a workflow, in accordance with some embodiments of the disclosure. The process 1100, as depicted in FIG. 1, may be implemented, in whole or in part, by systems or devices such as those shown in FIGS. 2-3. One or more actions of the process 1100 may be incorporated into or combined with one or more actions of any other process or embodiments described herein. The process 1100 may be saved to a memory or storage (e.g., any one of those depicted in FIGS. 2-3) as one or more instructions or routines that may be executed by a corresponding device or system to implement the method 1100.

Process 1100 may be used to input previously completed projects into an LLM and optimize and cluster, such as by using options of FIGS. 8 and 9, workflow steps of previously completed projects to then generate an optimized model that includes an optimized workflow. The optimized model that includes an optimized workflow may then be used to handle live projects.

In some embodiments, a workflow, where each workflow has a plurality of steps, is generated for each project that has been previously completed, such as projects 1-4 in FIG. 7. These workforce steps may be generated by the LLM by analyzing how a human agent handled a previous project. For example, as depicted in FIG. 10, based on the user-agent interaction 1010, and the analysis and plan performed by the agent 1020, an LLM may determine the workflow steps 1030 involved in the agent's responses (also referred to as a search and execute step). Analyzing each workflow for each project (from projects 1-4) at a time, or in a batch mode, the LLM may determine from a starting workflow step to an ending workflow step for each project, can the step be omitted, as depicted at 1120. The LLM may first analyze whether the step can be omitted for the first workflow step, and then continue its analysis for each subsequent step in the workflow, until all the steps have been evaluated for omission or elimination.

If a determination is made that the first workflow step can be omitted, then the process moves to block 1150 where a determination is made whether there is a subsequent workflow step in the workflow generated (e.g., workflow generated for project 1 in FIG. 7). If a determination is made at block 1150 that there is a subsequent workflow step in the workflow, then the process may move back to block 1120 where a determination is made whether the next workflow step can be omitted/eliminated.

There may be many reasons for a workflow step to be omitted. An agent while handling a live project, such a ticket, may perform additional steps for several reasons. For example, the agent may perform additional steps to determine the root cause, find an error, determine why the step is not being executed, determine why their approach is not successful, get a better understanding of the workflow step and what is needed to complete the workflow step, or may simply not know how to complete the step and as such may use a trial and error approach that may result in additional steps, which may be unnecessary, to be performed. As such, at block 1120, the LLM may use deep learning and other tools available to determine whether a step performed by the agent was necessary or it could have been omitted and by doing so would not affect the final result.

If a determination is made at block 1120 that the workflow step cannot be omitted, because it may be needed in the workflow, then at block 1125 another determination may be made whether information relating to the workflow step can be looked up. If a determination is made that the information cannot be looked up, then the LLM may determine at block 1130 that a workflow step involving a request to the user for seeking information related to the workflow step may be used in the optimized workflow.

In some embodiments, the agent may have queried the user and asked for information when such information could be looked up within the enterprise. The agent may have done so since the agent did not have the knowledge that such information can be obtained within the enterprise or did not know how to obtain such information. The agent may have also queried the user based on their style of handling the project. As such, when a workflow step in which the agent queried the user is detected, the LLM may determine whether such information could have been obtained without querying the user, such by the LLM querying a semantic graph that indexes of all knowledge in the enterprise, rather than requesting it from the user and adding an additional step. If a determination is made at block 1125 that the information can be looked up, then the agent's workflow step of querying the user may not be adopted in the optimized workflow.

If a determination is made at block 1125 that the information can be looked up, then the process may proceed to step 1135 where another determination is made if a tool to process the step is available. If a determination is made at block 1135 that a tool to process the workflow step is not available, then in the optimized workflow, the LLM may automatically generate the tool that is needed to complete the workflow step. In yet other embodiments, an alert may be displayed indicating that the tool is not available.

If a determination is made at block 1135 that a tool to process the workflow step is available, then the LLM may adopt the steps used by the agent for using the tool into the optimized workflow. In some embodiments, prior to adopting the steps used by the agent for using the tool into the optimized workflow, the LLM may curate and optimize the steps and then incorporate them into the optimized workflow.

At block 1145 another determination may be made whether the agent escalated a step in the workflow. If a determination is made that an escalation was made, then the process described in FIG. 12 may be implemented. Additional details relating to handling escalations is provided in FIG. 12.

In some embodiments, yet another determination that may be made includes determining whether the workflow involves a subsequent workflow step at block 1150. If another step in the workflow exists following a step that has been evaluated through blocks 1120-1155, then the process may be repeated for the next subsequent step in the workflow until all steps in the workflow for a completed project have been evaluated to determine whether such workflow steps are to be included in the optimized model having an optimized workflow with optimized steps. Inclusion of the step may also involve using a revised or improvised version of the step, copying some but not all portions of the step, and not copying the step in its entirety

In some embodiments, process 1100 may be used to evaluate each step in a workflow of a completed project. The evaluations may include a) determining whether the workflow step used by an agent should be incorporated into the optimized workflow b) whether the workflow step can be omitted, c) whether information relating to the workflow step could have been looked up, d) whether workflow steps that involve use a tool should be incorporated in the optimized workflow, e) whether new workflow steps should be generated in the optimized workflow since the tool was not available to the agent, and f) whether an escalation took place and if so what steps from the escalation should be optimized and adopted. Additional evaluations that are inputted by an enterprise may also be used to evaluate workflow steps of the completed project for their use in the optimized workflow.

The LLM may perform process 1100 on all the projects and their workflows, such as projects 1-4 depicted in FIG. 7. The LLM may then apply the clustering options and optimization factors, as described in FIGS. 8 and 9, to then generate the optimized model which includes the optimized workflow for handling live projects.

FIG. 12 is a flowchart of an example of a process for evaluating escalations and determining whether to incorporate escalation related workflow steps into the optimized workflow, in accordance with some embodiments of the disclosure. The process 1200, as depicted in FIG. 1, may be implemented, in whole or in part, by systems or devices such as those shown in FIGS. 2-3. One or more actions of the process 1200 may be incorporated into or combined with one or more actions of any other process or embodiments described herein. The process 1200 may be saved to a memory or storage (e.g., any one of those depicted in FIGS. 2-3) as one or more instructions or routines that may be executed by a corresponding device or system to implement the method 1200.

In some embodiments, at block 1210 an escalation in a previous project may be detected or identified. The escalation may have been performed at a particular step of the workflow by an agent.

At blocks 1215 a determination may be made whether the escalation related to use of an application to complete the task. For example, the agent may have used an external or internal application, such as Salesforce application, or in instances where the agent did not have expertise or authorization to use such as internal/external application, escalated it to a person in the enterprise that is skilled in using the interna/external application to perform the workflow step.

At blocks 1220 a determination may be made whether the escalation related to use of human skills and resources, such as using skills of another colleague in the engineering department to perform a calculation, or someone skilled in the marketing department to provide a discount coupon, etc.

If a determination is made that the escalation did not relate to use of an application or use of skills from a known individual or department, then at block 1225 further investigation may be performed to determine the purpose of the escalation, skills needed for the escalation, and other escalation related details.

At block 1230 a determination may be made whether the escalation could have been avoided. In some embodiments, while handling a live ticket an agent may have escalated an issue presented in a step of a workflow which did not need escalation. For example, the issue related to the workflow step could have been solved by the agent if the agent had requisite knowledge or resources to solve the issue.

If a determination is made at block 1230 that the escalation could have been avoided, then, at block 1235, the workforce step relating to the escalation may not be incorporated into the optimized workflow. In other words, the optimized workflow would not include an escalation or workflow steps associated with the escalation performed by the agent.

A determination may be made at block 1240 whether the escalation resolved the issue that may have been presented in the workflow step that provided the basis for the escalation. If a determination is made that the escalation resolved the issue presented in the workflow step, then the workflow steps, methods, processes, calculations, and other functions performed during the escalation may be determined at block 1245 and incorporated into the optimized workflow at block 1250. The LLM may also perform additional analysis of the workforce steps used to resolve the escalation at block 1245 and further refine, curate, and optimize such workflow steps related to escalation prior to adopting them in the optimized workflow at block 1250.

If a determination is made at block 1240 that the escalation did not resolve the issues in the workflow step, then at block 1255, the LLM may determine alternative workflow steps that provide an alternative solution to resolving the issues raised in the workflow step and incorporate them in the optimized workflow.

Once it is determined that an escalation is needed and steps for escalation should be incorporated in the optimized workflow, a final check may be made by the LLM to determine capability to escalate and availability of resources for escalation. In some instances, the enterprise may not have the capability for skills that are needed for escalation, e.g. engineering skill needed to perform the calculations may not exist. In another example, the enterprise may not have a specific application needed to complete the workflow step or may not have a subscription with the vendor that hosts the application. If both capability and availability is determined, only then the escalation steps may be incorporated into the final optimized workflow.

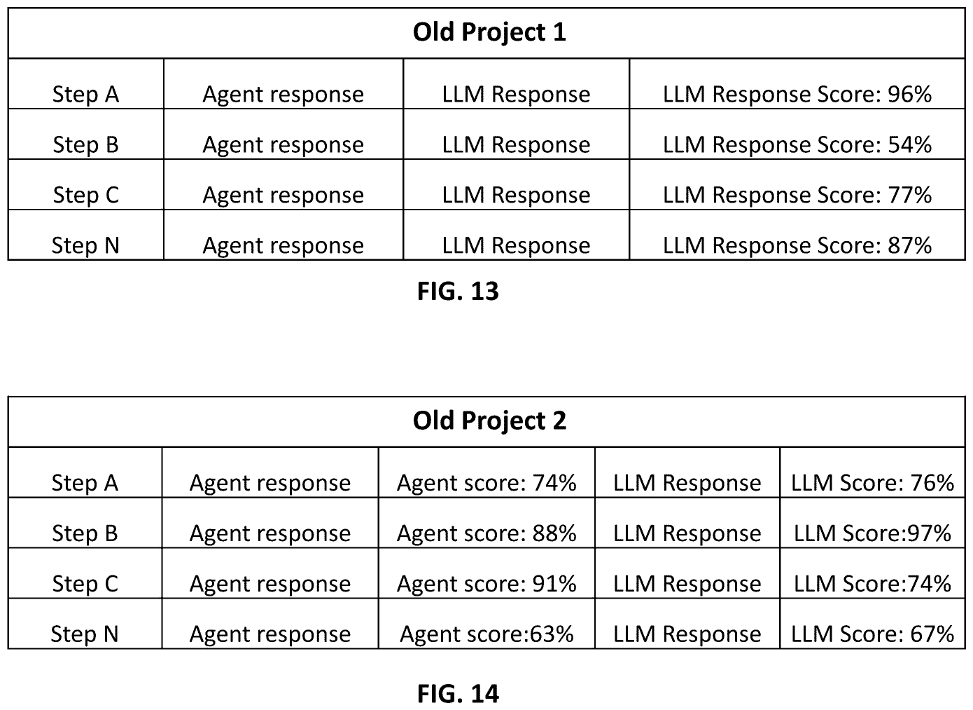

FIG. 13 is a block diagram of scores calculated based on the similarity between an LLM response and a live agent response for an already executed project and FIG. 14 is a block diagram of comparing agent score and LLM score, based on their responses for an already executed project, to a predetermined standard, in accordance with some embodiments of the disclosure.

Once an optimized model having an optimized workflow is generated, it may be tested on previously completed projects to determine whether an LLM response based on the optimized model measures up to the agent's response. Since the agent's response on a previously completed project is already known, the testing may be used to provide a confidence whether the generated optimized model with the optimized workflow provides responses that are same or better than the responses actually provided by the agents. As such, in some embodiments, for the purposes of testing, the previously completed projects may be projects that are different that the projects used to train the LLM. In other embodiments, projects used for training the LLM may also be used to test the LLM that uses the optimized model with the optimized workflow.

In one embodiment, in FIG. 13, the agent's response may be taken as a gold standard and the LLM response may be measured up to the agent's response. In another embodiment, in FIG. 14, both the agent's response and the LLM response may be measured to a predetermined standard or an industry standard.

Referring to FIG. 13, in some embodiments, a previously completed project, such as project 1 from FIG. 7, may include a plurality of workflow steps. For example, the workflow steps in project 1 may include steps A-N. For each step in the workflow of project 1, the agent may have responded in a particular manner to the user. Masking the response that the agent provided for a particular step, the LLM, using the optimized model, may provide a response for the same particular step. The LLM provided response may then be measured with the actual agent provided response, such as for the same step A of project 1. The agent response may be unmasked after the LLM provides the response such that both responses can be compared. In one example, the LLM provided response may have scored 96%, i.e., it may be 96% similar to what the agent actually responded to in step A of project 1. Likewise, for step B, the LLM response may have scored 54%, i.e., it may be 54% similar to what the agent actually responded to in step B of project 1. Likewise, LLM response may have scored 77% for step C and 87% for step N.

In some embodiments, all the LLM responses for each step of the workflow of project 1 may be analyzed with respect to the agent's actual response for a previously completed project. The analysis may include comparing to a predetermined threshold (e.g., +/−5% of agent's response) to determine whether the LLM response was within a threshold of the agent's response. If not, then a determination may be made whether the model used by the LLM, i.e., the optimized workflow model needs further refinement and optimization, specifically relating to a particular step in the workflow where the LLM response was below the predetermined threshold.

For example, an LLM response using the optimized model, such as for step B, may have scored 54% of what the agent had responded to. If a predetermined threshold has been set that any LLM response should be 90% similar to the agent's response, since the response by LLM scored 54% for step B, i.e. only 54% similar to the agent's response when 90% threshold has been set, a determination may be made that the LLM response for step B fell short of the threshold. In such a scenario, the model may be optimized to either adopt the steps used by the agent in the response or by determining an alternative approach to further refine and optimize the model used by the LLM, and test it again until the LLM response scores above the predetermined threshold.

Referring to FIG. 14, in some embodiments, the agent's response and the LLM's response for a particular step in the workflow may be measured to a predetermined threshold. In other words, both the agent and LLM response may be measured to an ideal response or a standard that the enterprise expects as a response for the workflow step. As depicted, the agent's response to a previously completed project for step A of the workflow may have scored 74% while the LLM may have scored 76%. Likewise, the agent's response to workflow step B may have scored 88% while the LLM response may have scored 97%. For yet another workflow step for project 2, the agent's response may have scored 91% while the LLM had scored 74%, and finally the agent's response to workflow step N may have scored 63% while the LLM score they have scored 67%.

In some embodiments, whichever response scores the higher of the two, the agent's response or the LLM response may be adopted into the optimized workflow. In another embodiment, a predetermined threshold may be set that requires the LLM response to score at least 5% higher than the agent's response for the workforce steps, processes, computations used in the LLM response to be adopted into the optimized workflow.

In yet another embodiment, both the agent's response and the LLM response may be held to a predetermined threshold for either of them to be included in the optimized workflow. For example, for step A, a predetermined threshold of 90% may be preset. Since neither the agent's response nor the LLM response scores 90%, neither of them would be adopted in the optimized model with the optimized workflow. In such a scenario, the LLM may revise and optimize the model until the LLM response reaches the predetermined 90% or some other predetermined threshold.

Although a few methods have been described in both FIGS. 13 and 14 related to measuring the LLM response and the agent's response with respect to each other or with respect to a predetermined threshold or a standard, the embodiments are not so limited and other formulas and methods may also be applied.

When either the agent response or the LLM response is accepted, as is or after being further optimized, such as for a particular step in the workflow, the steps taken by the agent or the LLM, which includes performing certain processes, calculations, escalations, or any other functions, may be incorporated into the optimized workflow and the optimized workflow may then be used for handling live projects.

FIG. 15 is a flowchart of an example of a process 1500 for testing the optimized model with the optimized workflow steps against an agent response and refining the model and its workflow steps as needed, in accordance with some embodiments of the disclosure. The process 1500, as depicted in FIG. 1, may be implemented, in whole or in part, by systems or devices such as those shown in FIGS. 2-3. One or more actions of the process 1500 may be incorporated into or combined with one or more actions of any other process or embodiments described herein. The process 1500 may be saved to a memory or storage (e.g., any one of those depicted in FIGS. 2-3) as one or more instructions or routines that may be executed by a corresponding device or system to implement the method 1500.

In some embodiments, once an optimized model has been generated, which includes an optimized workflow and optimized steps of the workflow, it may be tested and verified prior to use in an actual real-life setting to handle live projects, such as live tickets. The testing and verification may be performed on already completed projects such that the LLM response for each step of the workflow (or the project overall) can either be measured against an actual agent's response given in the completed projects or against a predetermined ideal response.

In some embodiments, a previously completed project, such as project 1 from FIG. 7, may include a plurality of workflow steps. For example, the workflow steps in project 1 may include steps A-N as depicted in FIGS. 13 and 14. For each step in the workflow of project 1 or project 2, the agent may have completed a particular task, responded to the user, looked up information, taken a substantive action, or responded in a particular manner to the user for the particular step. An LLM completion and/or response to the user may be performed for the same workflows and same steps as the agent and then determined whether the optimized model used by the LLM is performing as expected and ready to be used in real-life projects.

As such, the process of testing, verifying, and revising and further optimizing if needed, may include, in some embodiments, determining, at block 1510, whether there is additional data needed to perform a step of the optimized workflow or if there are any data updates that need to be incorporated in the optimized model. Since data in an enterprise changes continuously, if there are changes to the data, such data changes may affect how steps of the workflow model may be executed, the path taken by the workflow model, or the results of each workflow step. As such, prior to using the optimized model, or whenever an update is indicated, a query may be made if any data needs to be updated. If there are updates to the data, then such data relating to the update may be incorporated into the optimized model.

If there is such a need for additional data or there is an update to data, then at block 1520, the data may be obtained from a knowledge base 1530 and incorporated into the optimized workflow. In some embodiment, the process may include the LLM querying a semantic graph, which includes an index to all enterprise data, or an index to all enterprise data to which the user of the query is authorized to access based on their credential, job title, job function, department, etc., and may be updated periodically, to determine if there is a data update. If there is a data update, then the updated data may be obtained and incorporated into the optimized model.

In some embodiments, the workflow or the execution of workflow step may result in generating or obtaining data that is not currently available in the knowledge base. In such circumstances, data from the workflow may be stored into the knowledge base for later use.

In some embodiments, at 1540, using the optimized model, the LLM may provide a response to a particular step of the workflow or complete a particular step of the workflow. A determination may be made at block 1550 whether the LLM provided response or completion for the particular step is above a threshold. In some embodiments, the threshold may be provided by the enterprise as the standard that is used for measuring the LLM response and in other embodiments the threshold may be based on whether the LLM response or completion is within a threshold of similarity with the agent's response for an already completed project. For the purposes of testing and measuring the LLM response, in some embodiments, the previously completed projects that are different from the projects used to train the LLM may be used. In other embodiments, even projects used for training the LLM may be used to test the LLM response that uses the optimized model.

If a determination is made that the LLM response is not above a threshold, then the model may be optimized at block 1560, such as by leveraging the knowledge base 1530, adopting the agent's response, or using alternative methods and workflow steps than those used in the optimized model used by the LLM. The process may be repeated until the LLM response is above the threshold.

If a determination is made that the LLM response is above the threshold, then at block 1570 the LLM response may be adopted in the optimized workflow.

A determination may be made at block 1580 whether a subsequent or another step in the workflow exists, and if so, the process may be repeated from blocks 1540 to block 1580 until all the steps of the workflow have been completed.

If any changes are made based on the testing, a revised workflow model may be generated at block 1585 and tested and verified at block 1590. The model may be tested at block 1550 until the LLM responses are above a predetermined threshold. Once the workflow model used by the LLM has been optimized, revised, and further optimized as needed, it may be ready for use at block 1595 for new live projects.

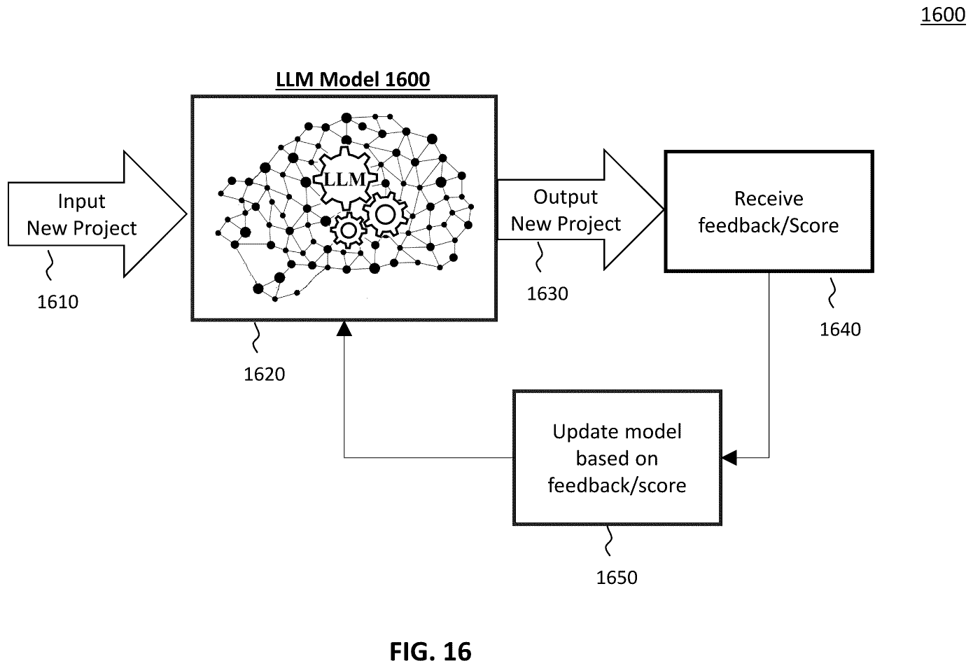

FIG. 16 is a flowchart of a process 1600 for using the optimized LLM model in a live environment to provide responses, in accordance with some embodiments of the disclosure. The process 1600, as depicted in FIG. 1, may be implemented, in whole or in part, by systems or devices such as those shown in FIGS. 2-3. One or more actions of the process 1600 may be incorporated into or combined with one or more actions of any other process or embodiments described herein. The process 1600 may be saved to a memory or storage (e.g., any one of those depicted in FIGS. 2-3) as one or more instructions or routines that may be executed by a corresponding device or system to implement the method 1600.

In some embodiments, a new project may be inputted at 1610 into the LLM model 1600. The LLM model 1600 may use an optimized workflow having optimized workflow steps for completing the project inputted at block 1610. The LLM model may then execute the optimized workflow that was generated based on the processes described herein, including the processes of FIGS. 11, 12, and 15. The LLM may then, after executing the steps of the optimized workflow, may generate an output 1630. In some embodiments, the output may be customized to the persona of the user that inputted the new project at 1610. If any feedback is received at block 1640, or if the output project scores below a threshold, then such feedback and score may be used at block 1650 to update the model used by the LLM to provide the response. The feedback loop that includes the steps 1620-1650 may be repeated, as needed, until the output at 1630 receives a score above a predetermined threshold.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving a plurality of completed projects that include a conversation between at least two entities to perform a task;
categorizing the completed projects into groups based on a common attribute shared by the completed projects, wherein categorization includes categorizing the completed projects at least into a first category and a second category;
determining an optimized workflow based on a plurality of workflows from the first category of completed projects;
training a language model using the optimized workflow associated with the first category of completed projects;
testing the language model trained with the optimized workflow to determine a testing score; and
in response to determining that the testing score is above a predetermined threshold, using the language model trained with the optimized workflow to provide responses to live queries.

2. The method of claim 1, wherein determining an optimized workflow based on a plurality of workflows from the first category of completed projects further comprises:
determining a first workflow of a first project, from the plurality of completed projects, associated with the first category;
determining a second workflow of a second project, from the completed projects, associated with the first category;
analyzing the first and the second workflows to identify one or more redundancies; and
eliminating the identified one or more redundancies to generate the optimized workflow.

3. The method of claim 2, further comprising, retaining steps common to both the first and the second workflow to generate the optimized workflow, wherein the optimized workflow includes the steps common to both the first and the second workflow and eliminates the one or more redundancies.

4. The method of claim 1, wherein the optimized workflow includes essential steps required to complete a task.

5. The method of claim 1, wherein determining an optimized workflow based on a plurality of workflows from the first category of completed projects further comprises:
determining a first workflow of a first project, from the plurality of completed projects, associated with the first category;
determining that a step of the first workflow was escalated; and
in response to determining that step of the first workflow was escalated, determining whether the escalation resulted in solving an issue for which the step of workflow was escalated.

6. The method of claim 5, further comprising:
determining that the escalation resulted in solving the issue for which the step of workflow was escalated; and
in response to determining that the escalation resulted in solving the issue for which the step of workflow was escalated:
analyzing steps used in the escalation to solve the issue for which the step of workflow was escalated; and
curating the steps used in the escalation; and
adopting the curated steps into the optimized workflow.

7. The method of claim 5, further comprising:
determining that the escalation did not result in solving the issue for which the step of workflow was escalated; and
in response to determining that the escalation did not result in solving the issue for which the step of workflow was escalated: determining an alternative solution to the escalation for solving the issue for which the step of workflow was escalated.

8. The method of claim 1, wherein testing the language model trained with the optimized workflow to determine the testing score further comprises:
comparing a response provided by the language model with a response provided by a first entity, from the two entities, for a first project, from the plurality of completed projects; and
associating, based on the comparison, the response provided by the language model with the testing score that is above the predetermined threshold if the response provided by the language model is within a threshold of the response provided by the first entity.

9. The method of claim 8, wherein the first entity is a human agent.

10. The method of claim 1, further comprising:
determining that a second step of the optimized workflow requires a tool for completion of the second step;
determining unavailability of the tool for completion of the second step; and
in response to determining unavailability of the tool for completion of the second step, using the language model to generate code that provides that functionality of the tool required for completion of the second step.

11. The method of claim 1, wherein determining the optimized workflow based on the plurality of workflows from the first category of completed projects further comprises:
determining that a majority of workflows, from the plurality of workflows, do not use a particular step that is used by a minority of workflows, from the plurality of workflows; and
in response to determining that the majority of workflows do not use the particular step, eliminating the particular step not used by the majority of workflows from the optimized workflow.

12. A system comprising:
communications circuitry configured to access a plurality of completed projects saved in a database; and
control circuitry configured to:
receive the plurality of completed projects that include a conversation between at least two entities to perform a task;
categorize the completed projects into groups based on a common attribute shared by the completed projects, wherein categorization includes categorizing the completed projects at least into a first category and a second category;
determine an optimized workflow based on a plurality of workflows from the first category of completed projects;
train a language model using the optimized workflow associated with the first category of completed projects;
test the language model trained with the optimized workflow to determine a testing score; and
in response to determining that testing score is above a predetermined threshold, use the language model trained with the optimized workflow to provide responses to live queries.

13. The system of claim 12, wherein determining an optimized workflow based on a plurality of workflows from the first category of completed projects further comprises, the control circuitry configured to:
determine a first workflow of a first project, from the plurality of completed projects, associated with the first category;
determine a second workflow of a second project, from the completed projects, associated with the first category;
analyze the first and the second workflows to identify one or more redundancies; and
eliminate the identified one or more redundancies to generate the optimized workflow.

14. The system of claim 13, further comprising, the control circuitry configured to retain steps common to both the first and the second workflow to generate the optimized workflow, wherein the optimized workflow includes the steps common to both the first and the second workflow and eliminates the one or more redundancies.

15. The system of claim 12, wherein determining an optimized workflow based on a plurality of workflows from the first category of completed projects further comprises, the control circuitry configured to:
determine a first workflow of a first project, from the plurality of completed projects, associated with the first category;
determine that a step of the first workflow was escalated; and
in response to determining that step of the first workflow was escalated, determine whether the escalation resulted in solving an issue for which the step of workflow was escalated.

16. The system of claim 15, further comprising, the control circuitry configured to:
determine that the escalation resulted in solving the issue for which the step of workflow was escalated; and
in response to determining that the escalation resulted in solving the issue for which the step of workflow was escalated:
analyze steps used in the escalation to solve the issue for which the step of workflow was escalated; and
curate the steps used in the escalation; and
adopt the curated steps into the optimized workflow.

17. The system of claim 15, further comprising, the control circuitry configured to:
determining that the escalation did not result in solving the issue for which the step of workflow was escalated; and
in response to determining that the escalation did not result in solving the issue for which the step of workflow was escalated: determining an alternative solution to the escalation for solving the issue for which the step of workflow was escalated.

18. The system of claim 12, wherein testing the language model trained with the optimized workflow to determine the testing score further comprises, the control circuitry configured to:
compare a response provided by the language model with a response provided by a first entity, from the two entities, for a first project, from the plurality of completed projects; and
associate, based on the comparing, the response provided by the language model with the testing score that is above the predetermined threshold if the response provided by the language model is within a threshold of the response provided by the first entity.

19. The system of claim 12, further comprising, the control circuitry configured to:
determine that a second step of the optimized workflow requires a tool for completion of the second step;
determine unavailability of the tool for completion of the second step; and
in response to determining unavailability of the tool for completion of the second step, use the language model to generate code that provides that functionality of the tool required for completion of the second step.

20. The system of claim 12, wherein determining the optimized workflow based on the plurality of workflows from the first category of completed projects further comprises:
determine that a majority of workflows, from the plurality of workflows, do not use a particular step that is used by a minority of workflows, from the plurality of workflows; and
in response to determining that the majority of workflows do not use the particular step, eliminate the particular step not used by the majority of workflows from the optimized workflow.
